(19) United States
(12) Patent Application Publication
(10) Pub. No.: US 2021/0192756 A1
(43) Pub. Date: Jun. 24, 2021

(54) PARTITIONING AND TRACKING OBJECT DETECTION

(71) Applicant: QUALCOMM Incorporated, San Diego, CA (US)

(72) Inventors: Chun-Ting Huang, San Diego, CA (US); Lei Wang, Clovis, CA (US); Ning Bi, San Diego, CA (US); Alex Jong, San Diego, CA (US)

(21) Appl. No.: 16/719,062

(22) Filed: Dec. 18, 2019

(51) Int. Cl. G06T 7/246; G06T 7/238; G06T 7/215; G06T 7/73; G06N 3/04

(52) U.S. Cl. CPC G06T 7/248; G06T 7/238; G06T 2210/12; G06T 7/74; G06N 3/0454; G06T 7/215

(57) ABSTRACT

Methods, systems, and devices for image processing are described. A device may receive a first frame including a candidate object. The device may detect first object recognition information based on the first frame or a portion of the first frame. The first object recognition information may include the candidate object or a first candidate bounding box associated with the candidate object. The device may detect second object recognition information based on the first object recognition information, a second frame, or a portion of the second frame. The second object recognition information may include the candidate object in the second frame, a second candidate bounding box associated with the candidate object, or features of the candidate object. The device may estimate motion information associated with the candidate object in the first frame, and track the candidate object in the second frame based on the motion information.

### TECHNICAL FIELD

The following relates generally to image processing and more specifically to partitioning and tracking object detection.

### BACKGROUND

Multimedia systems are widely deployed to provide various types of multimedia communication content such as voice, video, packet data, messaging, broadcast, and so on. These multimedia systems may be capable of processing, storage, generation, manipulation and rendition of multimedia information. Examples of multimedia systems include wireless communications systems, entertainment systems, information systems, virtual reality systems, model and simulation systems, and so on. These systems may employ a combination of hardware and software technologies to support processing, storage, generation, manipulation and rendition of multimedia information, for example, such as capture devices, storage devices, communication networks, computer systems, and display devices. As demand for multimedia communication efficiency increases, some multimedia systems, may fail to provide satisfactory multimedia operations for multimedia communications, and thereby may be unable to support high reliability or low latency multimedia operations, among other examples.

### SUMMARY

Various aspects of the described techniques relate to configuring a device to support partitioning workloads to improve the accuracy and efficiency of object recognition and tracking processes. The described techniques may be applied to configure object recognition and tracking systems, and in some examples, to an object recognition and tracking system configured to partition workloads for improved recognition and tracking. An object recognition and tracking system may include a device configured to perform object recognition using an object detection scheme or a partitioned object detection scheme having reduced computational costs for processing frames. In some examples, partitioned object detection may include distributing a workload for object recognition based on four partitioned types: (1) a scale for a first portion (e.g., a left part) of a frame, (2) a scale for a second portion (e.g., a right part) of the frame, (3) a scale for the entire frame, and (4) downscaling the entire frame.

Aspects described herein propose incorporating object detection using a cascaded neural network with tracking logic, which may support object recognition and object tracking having high efficiency, a high accuracy rate, and reduced processing overhead. A device may utilize an optical flow (e.g., motion estimation) to process outputs of any type of the partitioned object detection schemes. In some examples, the device may use a cascaded neural network (e.g., an output network (O-Net)) to refine or reject results (e.g., object recognition results) of the optical flow. In some examples, the device may include tracking logic configured to provide improved (e.g., faster and more accurate) object recognition and tracking, utilizing results determined by the object detection scheme (e.g., full and partitioned), results determined by the optical flow, and the refined results of the optical flow. In some examples, the object detection and tracking schemes may include facial recognition and facial tracking, for example, in-cabin driver monitoring.

A method of object detection or tracking is described. The method may include receiving a first frame including a candidate object, detecting, via a cascade neural network, first object recognition information based on one or more of the first frame or a portion of the first frame, the first object recognition information including one or more of the candidate object or a first candidate bounding box associated with the candidate object, detecting, via the cascade neural network, second object recognition information based on one or more of the first object recognition information, a second frame, or a portion of the second frame, the second object recognition information including one or more of the candidate object in the second frame, a second candidate bounding box associated with the candidate object, or one or more features of the candidate object, estimating, via the cascade neural network, motion information associated with the candidate object in the first frame, and tracking the candidate object in the second frame based on the motion information.

An apparatus for object detection or tracking is described. The apparatus may include a processor, memory coupled with the processor, and instructions stored in the memory. The instructions may be executable by the processor to cause the apparatus to receive a first frame including a candidate object, detect, via a cascade neural network, first object recognition information based on one or more of the first frame or a portion of the first frame, the first object recognition information including one or more of the candidate object or a first candidate bounding box associated with the candidate object, detect, via the cascade neural network, second object recognition information based on one or more of the first object recognition information, a second frame, or a portion of the second frame, the second object recognition information including one or more of the candidate object in the second frame, a second candidate bounding box associated with the candidate object, or one or more features of the candidate object, estimate, via the cascade neural network, motion information associated with the candidate object in the first frame, and track the candidate object in the second frame based on the motion information.

Another apparatus for object detection or tracking is described. The apparatus may include means for receiving a first frame including a candidate object, detecting, via a cascade neural network, first object recognition information based on one or more of the first frame or a portion of the first frame, the first object recognition information including one or more of the candidate object or a first candidate bounding box associated with the candidate object, detecting, via the cascade neural network, second object recognition information based on one or more of the first object recognition information, a second frame, or a portion of the second frame, the second object recognition information including one or more of the candidate object in the second frame, a second candidate bounding box associated with the candidate object, or one or more features of the candidate object, estimating, via the cascade neural network, motion information associated with the candidate object in the first frame, and tracking the candidate object in the second frame based on the motion information.

A non-transitory computer-readable medium storing code for object detection or tracking is described. The code may include instructions executable by a processor to receive a first frame including a candidate object, detect, via a cascade neural network, first object recognition information based on one or more of the first frame or a portion of the first frame, the first object recognition information including one or more of the candidate object or a first candidate bounding box associated with the candidate object, detect, via the cascade neural network, second object recognition information based on one or more of the first object recognition information, a second frame, or a portion of the second frame, the second object recognition information including one or more of the candidate object in the second frame, a second candidate bounding box associated with the candidate object, or one or more features of the candidate object, estimate, via the cascade neural network, motion information associated with the candidate object in the first frame, and track the candidate object in the second frame based on the motion information.

Some examples of the method, apparatuses, and non-transitory computer-readable medium described herein may further include operations, features, means, or instructions for determining, via the cascade neural network, third object recognition information based on the motion information, the third object recognition information including one or more of the candidate object, the first candidate bounding box associated with the candidate object, one or more object features of the candidate object, or a combination thereof, where tracking the candidate object in the second frame may be based on the third object recognition information.

Some examples of the method, apparatuses, and non-transitory computer-readable medium described herein may further include operations, features, means, or instructions for detecting one or more additional candidate objects in one or more of the first frame or the portion of the first frame, where the third object recognition information includes one or more of the one or more additional candidate objects or additional candidate bounding boxes associated with the one or more additional candidate objects.

Some examples of the method, apparatuses, and non-transitory computer-readable medium described herein may further include operations, features, means, or instructions for determining an absence of the candidate object over a quantity of frames, where the quantity of frames includes at least the first frame and the second frame, and pausing the tracking based on the absence of the candidate object over the quantity of frames.

Some examples of the method, apparatuses, and non-transitory computer-readable medium described herein may further include operations, features, means, or instructions for comparing the absence of the candidate object over the quantity of frames to a threshold, where pausing the tracking may be based on the absence of the candidate object over the quantity of frames satisfying the threshold.

Some examples of the method, apparatuses, and non-transitory computer-readable medium described herein may further include operations, features, means, or instructions for determining an absence of the candidate object over a quantity of frames, where the quantity of frames includes at least the first frame and the second frame, and terminating the tracking based on the absence of the candidate object over the quantity of frames.

Some examples of the method, apparatuses, and non-transitory computer-readable medium described herein may further include operations, features, means, or instructions for comparing the absence of the candidate object over the quantity of frames to a threshold, where terminating the tracking may be based on the absence of the candidate object over the quantity of frames satisfying the threshold.

Some examples of the method, apparatuses, and non-transitory computer-readable medium described herein may further include operations, features, means, or instructions for determining, based on the second object recognition information, a first confidence score of one or more of the candidate object in the second frame, the second candidate bounding box associated with the candidate object, or the one or more features of the candidate object, determining, based on the third object recognition information, a second confidence score of one or more of the candidate object, the first candidate bounding box associated with the candidate object, one or more object features of the candidate object, or a combination thereof, where tracking the candidate object in the second frame may be based on one or more of the first confidence score or the second confidence score.

Some examples of the method, apparatuses, and non-transitory computer-readable medium described herein may further include operations, features, means, or instructions for determining a union between the second object recognition information and the third object recognition information by comparing the second object recognition information and the third object recognition information, and determining that the union satisfies a threshold, where tracking the candidate object in the second frame may be based on the union satisfying the threshold.

In some examples of the method, apparatuses, and non-transitory computer-readable medium described herein, detecting the first object recognition information further may include operations, features, means, or instructions for scaling one or more of the first frame or the portion of the first frame based on a parameter, where detecting the first object recognition information including one or more of the candidate object or the first candidate bounding box associated with the candidate object may be based on the scaling.

In some examples of the method, apparatuses, and non-transitory computer-readable medium described herein, detecting the second object recognition information further may include operations, features, means, or instructions for scaling one or more of the second frame or the portion of the second frame based on a parameter, where detecting the second object recognition information including one or more of the candidate object in the second frame, the second candidate bounding box associated with the candidate object, or the one or more features of the candidate object may be based on the scaling.

In some examples of the method, apparatuses, and non-transitory computer-readable medium described herein, detecting the first object recognition information further may include operations, features, means, or instructions for detecting the first object recognition information based on a frame count associated with the first frame, and detecting the second object recognition information further may include operations, features, means, or instructions for detecting the second object recognition information based on one or more of the frame count associated with the first frame or a frame count associated with the second frame.

Some examples of the method, apparatuses, and non-transitory computer-readable medium described herein may further include operations, features, means, or instructions for capturing one or more of the first frame, the second frame, or a third frame, estimating second motion information associated with the candidate object in the second frame, and tracking the candidate object in the third frame based on the second motion information.

In some examples of the method, apparatuses, and non-transitory computer-readable medium described herein, one or more of the first frame, the second frame, or the third frame may be contiguous.

In some examples of the method, apparatuses, and non-transitory computer-readable medium described herein, one or more of the first frame, the second frame, or the third frame may be noncontiguous.

### BRIEF DESCRIPTION OF THE DRAWINGS

FIG. 1 illustrates an example of a multimedia system that supports partitioning and tracking object detection in accordance with aspects of the present disclosure.

FIG. 2 illustrates an example method that supports partitioning and tracking object detection in accordance with aspects of the present disclosure.

FIGS. 3A through 3C illustrate example block diagrams that support partitioning and tracking object detection in accordance with aspects of the present disclosure.

FIG. 4 illustrates an example flowchart that supports partitioning and tracking object detection in accordance with aspects of the present disclosure.

FIGS. 5 and 6 show block diagrams of devices that support partitioning and tracking object detection in accordance with aspects of the present disclosure.

FIG. 7 shows a block diagram of a multimedia manager that supports partitioning and tracking object detection in accordance with aspects of the present disclosure.

FIG. 8 shows a diagram of a system including a device that supports partitioning and tracking object detection in accordance with aspects of the present disclosure.

FIGS. 9 through 11 show flowcharts illustrating methods that support partitioning and tracking object detection in accordance with aspects of the present disclosure.

### DETAILED DESCRIPTION

Object detection and tracking have been incorporated in applications such as surveillance applications, driver monitoring applications, and object tracking (e.g., facial tracking) applications, for example. Some techniques, to achieve real-time computation, have sacrificed performance in exchange for lighter workloads. Some deep learning strategies have been applied to object detection (e.g., facial recognition) to achieve improved detection rates, however, such strategies have been unable to efficiently address power consumption and processing time. Some other approaches have incorporated object tracking, such as optical flow, to reduce runtime and power. However, such approaches may suffer from degraded detection performance due to propagated frame-to-frame errors. Therefore, techniques capable of balancing between object detection and object tracking (e.g., facial recognition and facial tracking) are desired.

Some recognition systems deployed to provide object recognition information use object detection models, such as the Viola-Jones algorithm, in combination with tracking models, such as the Kanade-Lucas-Tomasi (KLT) algorithm, to provide real-time object detection and tracking. For example, some recognition systems may apply feature extractors such as corner detection to obtain key points in an object area, in combination with an optical flow procedure to compare previously captured frames and current frames including the object. However, such recognition systems experience a significant degradation in performance at the optical flow procedure due to prediction error, which may propagate frame by frame if no new detection is performed. Improved techniques capable of utilizing the detection accuracy of deep-learning based object detection while reducing computational cost are desired.

Various aspects of the described techniques relate to configuring a device to support object recognition and tracking systems, and in some examples, relate to an object recognition and tracking system configured to partition workloads for improved recognition and tracking. In some examples, a device may perform object recognition using an object detection scheme or a partitioned object detection scheme for processing frames. The partitioned object detection may include features for distributing a workload for object recognition using a combination of multiple stages and multiple scales. For example, the partitioned object detection include workload distribution based on four partitioned types: (1) a scale for a first portion (e.g., a left part) of a frame; (2) a scale for a second portion (e.g., a right part) of the frame; (3) a scale for the entire frame; and (4) downscaling the entire frame. In some examples, the object recognition may include, for example, omni-directional object detection. The device may utilize an optical flow (e.g., motion estimation) to process outputs of any type of the partitioned face detection scheme. The device may utilize a cascaded neural network (e.g., an output network (O-Net)) to refine or reject facial recognition results determined by the optical flow. Tracking logic may utilize results output from the face detection scheme (e.g., full and partitioned), the optical flow, or the refined results of the optical flow to provide faster and more accurate facial recognition and tracking.

Particular aspects of the subject matter described herein may be implemented to realize one or more advantages. The techniques employed by the described devices may provide benefits and enhancements to the operation of the devices. For example, operations performed by the described devices may provide improvements to object detection and tracking, and more specifically to partitioned object detection supportive of object tracking.

In some examples, configuring the described devices with the partitioned object detection may support improvements in distributing a workload for object recognition, improving processing time, processing efficiency, and reducing overhead, and, in some examples, may promote reduced execution times and processor overhead for object detection and object tracking, among other benefits.

Aspects of the disclosure are initially described in the context of multimedia systems. Aspects of the disclosure are further illustrated by and described with reference to apparatus diagrams, system diagrams, and flowcharts that relate to partitioning and tracking object detection.

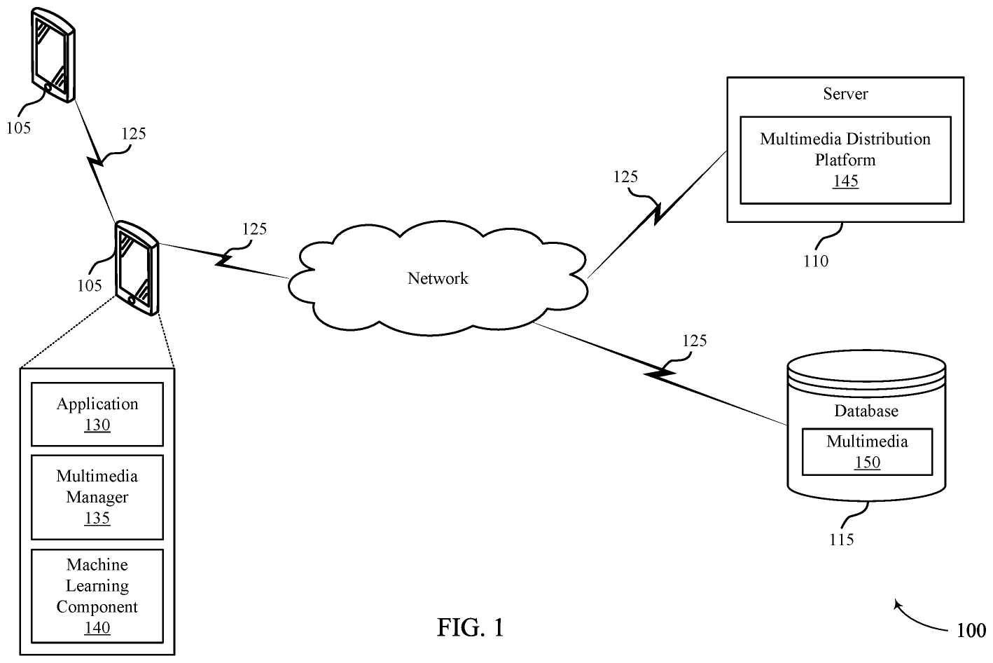

FIG. 1 illustrates an example of a multimedia system 100 that supports partitioning and tracking object detection in accordance with aspects of the present disclosure. The multimedia system 100 may include devices 105, a server 110, and a database 115. Although the multimedia system 100 illustrates two devices 105, a single server 110, a single database 115, and a single network 120, the present disclosure applies to any multimedia system architecture having one or more devices 105, servers 110, databases 115, and networks 120. The devices 105, the server 110, and the database 115 may communicate with each other and exchange information that supports partitioning and tracking object detection, such as multimedia packets, multimedia data, or multimedia control information, via network 120 using communications links 125. In some examples, a portion or all of the techniques described herein supporting partitioning and tracking object detection may be performed by the devices 105 or the server 110, or both.

A device 105 may be a cellular phone, a smartphone, a personal digital assistant (PDA), a wireless communication device, a handheld device, a tablet computer, a laptop computer, a cordless phone, a display device (e.g., monitors), and/or the like that supports various types of communication and functional features related to multimedia (e.g., transmitting, receiving, broadcasting, streaming, sinking, capturing, storing, and recording multimedia data). A device 105 may, additionally or alternatively, be referred to by those skilled in the art as a user equipment (UE), a user device, a smartphone, a Bluetooth device, a Wi-Fi device, a mobile station, a subscriber station, a mobile unit, a subscriber unit, a wireless unit, a remote unit, a mobile device, a wireless device, a wireless communications device, a remote device, an access terminal, a mobile terminal, a wireless terminal, a remote terminal, a handset, a user agent, a mobile client, a client, and/or some other suitable terminology. In some examples, the devices 105 may also be able to communicate directly with another device (e.g., using a peer-to-peer (P2P) or device-to-device (D2D) protocol). For example, a device 105 may be able to receive from or transmit to another device 105 variety of information, such as instructions or commands (e.g., multimedia-related information).

The devices 105 may include an application 130, a multimedia manager 135, and a machine learning component 140. While the multimedia system 100 illustrates the devices 105 including the application 130, the multimedia manager 135, and the machine learning component 140, these features may be optional for the devices 105. In some examples, the application 130 may be a multimedia-based application that can receive (e.g., download, stream, broadcast) from the server 110, database 115 or another device 105, or transmit (e.g., upload) multimedia data to the server 110, the database 115, or to another device 105 via using communications links 125.

The multimedia manager 135 may be part of a general-purpose processor, a digital signal processor (DSP), an image signal processor (ISP), a central processing unit (CPU), a graphics processing unit (GPU), a microcontroller, an application-specific integrated circuit (ASIC), a field-programmable gate array (FPGA), a discrete gate or transistor logic component, a discrete hardware component, or any combination thereof, or other programmable logic device, discrete gate or transistor logic, discrete hardware components, or any combination thereof designed to perform the functions described in the present disclosure, and/or the like. For example, the multimedia manager 135 may process multimedia (e.g., image data, video data, audio data) from and/or write multimedia data to a local memory of the device 105 or to the database 115.

The multimedia manager 135 may also be configured to provide multimedia enhancements, multimedia restoration, multimedia analysis, multimedia compression, multimedia streaming, and multimedia synthesis, among other functionality. For example, the multimedia manager 135 may perform white balancing, cropping, scaling (e.g., multimedia compression), adjusting a resolution, multimedia stitching, color processing, multimedia filtering, spatial multimedia filtering, artifact removal, frame rate adjustments, multimedia encoding, multimedia decoding, and multimedia filtering. By further example, the multimedia manager 135 may process multimedia data to support partitioning and tracking object detection, according to the techniques described herein. For example, the multimedia manager 135 may employ the machine learning component 140 to process content of the application 130.

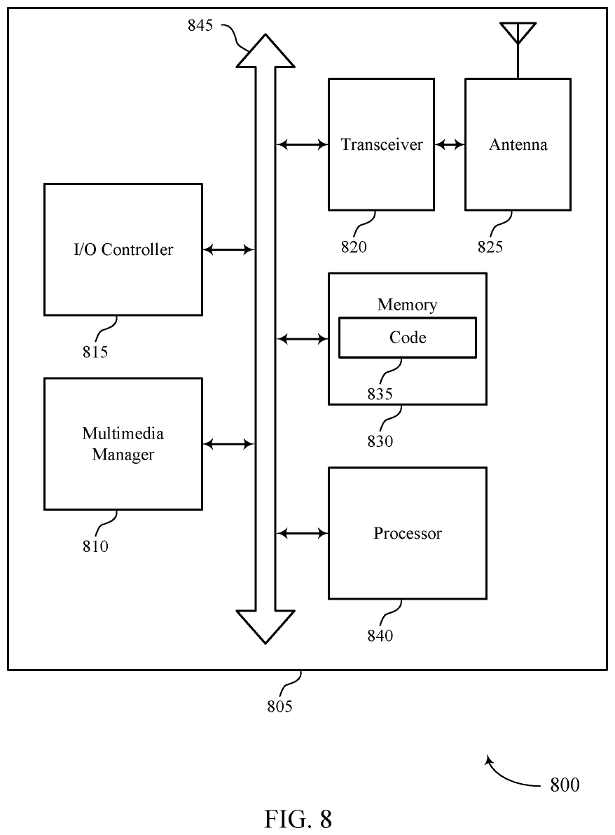

The machine learning component 140 may be implemented by aspects of a processor, for example, such as processor 840 described in FIG. 8. The machine learning component 140 may include a machine learning network (e.g., a neural network, a deep neural network, a cascade neural network, a convolutional neural network, a cascaded convolutional neural network, a trained neural network, etc.). In some examples, the machine learning component 140 may perform learning-based object recognition processing on content (e.g., multimedia content, such as image frames or video frames) of the application 130 to support partitioning and tracking object detection according to the techniques described herein.

In some examples, the machine learning component 140 may have multiple stages, each having a separate learning network that may process a frame (e.g., an image frame, a video frame). For example, a first stage of the machine learning component 140 may have a first network (e.g., a proposal network (P-Net)), a second stage of the machine learning component 140 may have a second network (e.g., a refinement network (R-Net)), and a third stage of the machine learning component 140 may have a third network (e.g., an output network (O-Net)). At each stage of the machine learning component 140, the device 105 may output a number of results based on frame processing performed by the network associated with the stage.

For example, at the first stage (e.g., using the first network), the device 105 may perform object detection at one or more angular positions of a frame and detect a first classification score (e.g., a confidence score) and a first bounding box location (e.g., a candidate bounding box location) for each of a number of candidate objects in a scene (e.g., in the frame). At the second stage (e.g., using the second network), the device 105 may refine the outputs of the first stage and output a second classification score (e.g., a confidence score) and a second bounding box location, as well as a number of landmarks (e.g., object features) and an up-right determination. At the third stage (e.g., using the third network), the device 105 may refine the outputs of the second stage and output a third classification score (e.g., a confidence score), a third bounding box location, a third number of landmarks (e.g., object features), and a third up-right determination. In some examples, the landmarks may include one or more object features associated with the detected candidate objects. In some examples, at each of the stages, the device 105 may determine a confidence score associated with each of the candidate objects (e.g., a confidence associated with the presence of the candidate object as predicted by the machine learning component 140). The device 105 (e.g., using the machine learning component 140) may perform object detection for objects at one or more orientations (e.g., with various roll angles) in a frame (e.g., an image frame, a video frame), for example, implementing aspects of an omni-directional object detection system.

In some examples, the machine learning component 140 may include a cascaded neural network. The cascaded convolutional neural network model may have multiple cascades (e.g., two or three cascades or stages) that may enable object recognition at various orientations. As such, use of the cascaded convolutional neural network model may allow the device 105 to perform object detection over multiple orientations (e.g., 0°, 90°, 180° , and 270°) of an image (e.g., a frame of a video image). Based on the results of the cascaded convolutional neural network, the device 105 may determine and output a value (e.g., a confidence score, a confidence level) associated with a candidate object in the image. For example, the value may be a confidence score based on the cascaded convolutional neural network's confidence associated with the candidate object in the image. In some examples, the machine learning component 140 may include multiple stages (e.g., a first stage (e.g., a detection stage), a second stage (e.g., a refinement stage), and a third stage (e.g., an output stage) associated with determining confidence scores associated with candidate objects).

Aspects of the described techniques may be applied to computer vision applications. For example, the device 105 may perform object detection and tracking associated with identifying and tracking objects present in images and videos. In some examples, the device 105 may apply object detection and tracking described herein to applications such as face detection, vehicle detection, pedestrian detection, autonomous vehicles, and security systems.

Various aspects of the described techniques relate to configuring the devices 105 to use learning-based recognition algorithms to enable the recognition and tracking of objects. A device 105 may receive a first frame including a candidate object. The device 105 may detect, via a cascade neural network, first object recognition information (e.g., a candidate object, a first candidate bounding box associated with the candidate object) based on one or more of the first frame or a portion of the first frame. The device 105 may detect, via the cascade neural network, second object recognition information (e.g., the candidate object, a second candidate bounding box associated with the candidate object, features of the candidate object) based on one or more of the first object recognition information, a second frame, or a portion of the second frame. In some examples, the device 105 may estimate, via the cascade neural network, motion information associated with the candidate object in the first frame, and track the candidate object in the second frame based on the motion information.

The multimedia manager 135 or the machine learning component 140, or both may provide improvements in omni-directional object detection and tracking for the devices 105. Furthermore, the techniques described herein may provide benefits and enhancements to the operation of the devices 105. For example, by employing a machine learning network with multiple cascaded networks, the operational characteristics, such as overhead, model size, power consumption, processor utilization (e.g., DSP, CPU, GPU, ISP processing utilization), and memory usage of the devices 105 may be reduced. The techniques described herein may also increase object detection efficiency in the devices 105 by reducing latency associated with processes related to object detection and tracking on mobile platforms (e.g., on the devices 105).

The server 110 may be a data server, a cloud server, a server associated with a multimedia subscription provider, proxy server, web server, application server, communications server, home server, mobile server, or any combination thereof. The server 110 may in some examples include a multimedia distribution platform 145. The multimedia distribution platform 145 may allow the devices 105 to discover, browse, share, and download multimedia via network 120 using communications links 125, and therefore provide a digital distribution of the multimedia from the multimedia distribution platform 145. As such, a digital distribution may be a form of delivering media content such as audio, video, images, without the use of physical media but over online delivery mediums, such as the Internet. For example, the devices 105 may upload or download multimedia-related applications for streaming, downloading, uploading, processing, enhancing, etc. multimedia (e.g., images, audio, video). The server 110 may also transmit to the devices 105 a variety of information, such as instructions or commands (e.g., multimedia-related information) to download multimedia-related applications on the device 105.

The database 115 may store a variety of information, such as instructions or commands (e.g., multimedia-related information). For example, the database 115 may store multimedia 150. The device 105 may support partitioning and tracking object detection associated with the multimedia 150. The device 105 may retrieve the stored data from the database 115 via the network 120 using communication links 125. In some examples, the database 115 may be a relational database (e.g., a relational database management system (RDBMS) or a Structured Query Language (SQL) database), a non-relational database, a network database, an object-oriented database, or other type of database, that stores the variety of information, such as instructions or commands (e.g., multimedia-related information).

The network 120 may provide encryption, access authorization, tracking, Internet Protocol (IP) connectivity, and other access, computation, modification, and/or functions. Examples of network 120 may include any combination of cloud networks, local area networks (LAN), wide area networks (WAN), virtual private networks (VPN), wireless networks (using 802.11, for example), cellular networks (using third generation (3G), fourth generation (4G), long-term evolved (LTE), or new radio (NR) systems (e.g., fifth generation (5G)), etc. The network 120 may include the Internet.

The communications links 125 shown in the multimedia system 100 may include uplink transmissions from the device 105 to the server 110 and the database 115, and/or downlink transmissions, from the server 110 and the database 115 to the device 105. The wireless links 125 may transmit bidirectional communications and/or unidirectional communications. In some examples, the communication links 125 may be a wired connection or a wireless connection, or both. For example, the communications links 125 may include one or more connections, including but not limited to, Wi-Fi, Bluetooth, Bluetooth low-energy (BLE), cellular, Z-WAVE, 802.11, peer-to-peer, LAN, wireless local area network (WLAN), Ethernet, FireWire, fiber optic, and/or other connection types related to wireless communication systems.

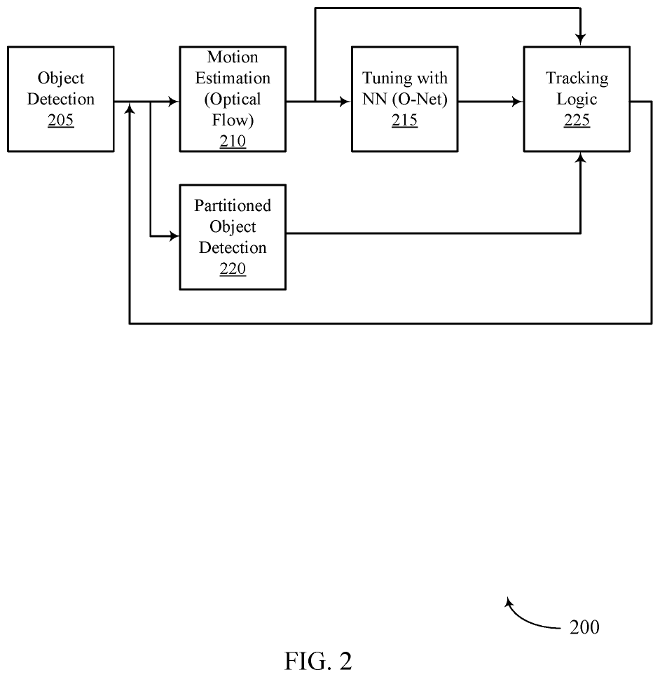

FIG. 2 illustrates an example method 200 that supports partitioning and tracking object detection in accordance with aspects of the present disclosure. The operations of method 200 may be implemented by a device 105 or its components as described herein. For example, the operations of method 200 may be performed by a multimedia manager or a machine learning component, or both as described with reference to FIG. 1. The machine learning component 140 may include, for example, a cascade neural network. Examples of the cascade neural network may include a convolutional neural network configured for omni-directional object detection. For example, the cascade neural network may include a convolutional neural network having multiple stages (e.g., three stages) for object detection or object classification, or both. The multiple stages may include a first stage (e.g., a detection stage), a second stage (e.g., a refinement stage), and a third stage (e.g., an output stage) associated with determining confidence scores associated with candidate objects. Aspects of the omni-directional object detection may include determining an object classification score, a bounding box location, a number of object landmarks, and an up-right object determination for each of a number of candidate objects. In some examples, the device 105 may execute a set of instructions to control the functional elements of the device to perform the functions described herein. Additionally or alternatively, the device 105 may perform aspects of the functions described herein using special-purpose hardware.

At 205, the device 105 may perform object detection. For the example, the device 105 may receive a first frame (e.g., an initial frame) including a candidate object, and in some examples, detect object recognition information associated with the candidate object in the first frame. The first frame may be, for example, a video image included in video captured by the device 105. In some examples, the first frame may be a video image received by the device 105 from another device 105, the server 110, or the database 115. For example, the device 105 may detect, via the machine learning component (e.g., the cascade neural network), first object recognition information based on one or more of the first frame or a portion of the first frame. The first object recognition information may include one or more of the candidate object or a first candidate bounding box associated with the candidate object. In some examples, the object recognition information described herein may include facial recognition information, and the candidate object may include a candidate face. According to examples of aspects described herein, the detection of object recognition information (e.g., first object recognition information) at 205 may include a full scan of a frame (e.g., the first frame) or a partitioned scan of the frame (e.g., a partitioned scan for a shorter runtime). In some examples, at 205, the device 105 may set a frame count to 0 (e.g., set a frame counter value to 0). Examples of aspects of partitioned scanning are described herein with respect to partitioned object detection.

At 210, the device 105 may perform motion estimation. For example, the device 105 may estimate, via the cascade neural network, motion information associated with the candidate object in the first frame. The device 105 may estimate the motion information using one or more optical flow techniques. The motion information may include estimated motion (e.g., local image motion) associated with the candidate object. In some examples, the device 105 may estimate motion associated with the candidate object based on a sequence of frames. The sequence of frames may include the first frame and frames subsequent (e.g., adjacent to) the first frame according to a time sequence or frame sequence.

The device 105 may estimate, via the cascade neural network, motion information associated with the candidate object in any frame of a sequence of frames. For example, based on the optical flow techniques, the device 105 may estimate motion (e.g., local image motion) associated with a candidate object based on a sequence of frames, where the sequence of frames includes a second frame and frames subsequent (e.g., adjacent to) the second frame according to a time sequence or frame sequence. According to examples of aspects described herein, based on the optical flow techniques at 210, the device 105 may estimate motion associated with the candidate object based on local derivatives in the sequence of frames. For example, the device 105 may estimate differences in image pixels (e.g., changes in position of each image pixel) between adjacent frames in a sequence of frames (e.g., a sequence of images). In some examples, using the optical flow techniques, the device 105 may measure variations of image brightness or brightness patterns associated with a moving image (e.g., moving objects in a scene). The device 105 may generate the sequence of frames based on images of a scene and objects included in the scene, as captured by a camera included in or coupled to the device 105. The sequence of frames, for example, may include two-dimensional (2D) frame sequences based on perspective projection associated with relative motion of the camera when capturing the images.

In some examples, for each subsequent frame of the sequence of frames, the device 105 (e.g., using the optical flow techniques) may utilize the output associated with a previous frame as the starting point for a new processing cycle (e.g., a processing cycle including motion estimation, tuning, partitioned object detection, and tracking logic). For example, for a next frame of the sequence of frames, the device 105 at 210 may calculate optical flow with respect to results from the previous frame (e.g., based on image pixels associated with a candidate object in the previous frame, compared to image pixels associated with the candidate object in the next frame). In some examples, at 215, the device 105 may perform tuning and set the frame count to ‘1’ (e.g., may add a ‘1’ to the frame count).

At 215, the device 105 may process the estimated motion (e.g., motion information) determined by the optical flow techniques at 210. At 215, for example, the device 105 may process the estimated motion using the machine learning component (e.g., the cascade neural network). For example, at 215, the device 105 may determine, via the machine learning component (e.g., the cascade neural network), third object recognition information based on the motion information. The third object recognition information may include one or more of the candidate object, the first candidate bounding box associated with the candidate object, one or more object features of the candidate object, or a combination thereof. In an example of determining the third object recognition information, the device 105 may utilize the machine learning component (e.g., the cascade neural network) to refine results associated with the estimated motion (e.g., motion information) determined at 210. For example, where the machine learning component has multiple stages as described herein, the device 105 may utilize a third stage of the machine learning component (e.g., utilize a third network, an output network (O-Net), of the third stage of the machine learning component for refining results associated with the estimated motion.

The estimated motion (e.g., motion information) determined at 210 may include candidate bounding boxes associated with a candidate object, for example, with respect to frames of a frame sequence. The device 105, at 215, may utilize the third network (e.g., the output network (O-Net)) to analyze the candidate bounding boxes associated with the candidate object. For example, the device 105 may narrow or refine the number of candidate bounding boxes based on confidence scores associated with the candidate bounding boxes (e.g., based on confidence scores which satisfy a threshold, for example, exceed a threshold). In an example, at 215, the device 105 may output different groups of candidate bounding boxes (e.g., ‘Onet_Boxes’ and ‘Miss_Boxes’) associated with the candidate object based on the analysis. In some examples, the device 105 may compare the candidate bounding boxes determined at 210 (e.g., determined using optical flow techniques) to the candidate bounding boxes determined at 215 (e.g., determined using the machine learning component). In some examples, the device 105 may identify any bounding boxes which were determined at 210 but not determined at 215 (e.g., bounding boxes not determined at 215 due to an erroneous pose, orientation, or location). In some examples, the device 105 may store the identified bounding boxes to a memory of the device 105 (e.g., to a temporary array) as ‘Miss_Boxes’ for further tracking.

For each bounding box included in the ‘Miss_Boxes,’ the device 105 may assign a frame count number to the candidate bounding box. The device 105 may track the candidate bounding box (e.g., track for the candidate object associated with the candidate bounding box) over subsequent frames based on the frame count number (e.g., up to the frame count number). For example, the device 105 may track for the candidate bounding box, even when the candidate bounding box is not present (e.g., when the device 105 does not detect the candidate bounding box), based on the frame count number (e.g., up to the frame count number). In an example, the device 105 may increase a frame counter for each subsequent frame the candidate bounding box is not present (e.g., when the device 105 does not detect the candidate bounding box), and the device 105 may pause or discontinue tracking the candidate bounding box (e.g., discontinue tracking for the candidate object associated with the candidate bounding box) when the frame counter is equal to or greater than the frame count number. In some examples, the device 105 may increase a frame counter for each subsequent frame the candidate bounding box is not present (e.g., when the device 105 does not detect the candidate bounding box) and, in some examples, reset the frame counter (e.g., reset the frame counter to zero) once the candidate bounding box is present (e.g., when the device 105 detects the candidate bounding box).

The device 105 may identify any bounding boxes which are determined at 210 and determined at 215. The device 105 may store the identified bounding boxes in the memory of the device 105, for example, as ‘Onet_Boxes’. The device 105 may, at 225, track bounding boxes determined at 210, bounding boxes determined at 215, or both. In some examples, at 215 (e.g., using one or more stages of the machine learning component, for example, at a third stage of the machine learning component) the device 105 may refine or reject predicted results determined at 210, which may improve performance of the tracking at 225. For example, the device 105 may output, at the third stage of the machine learning component (e.g., at the output network (O-Net)), a refined list of predicted bounding boxes associated with a candidate object and confidence scores associated with the predicted bounding boxes. In some examples, the device 105 may compare the confidence scores of candidate bounding boxes to a threshold, and for each score failing to satisfy the threshold (e.g., below the threshold), remove the candidate bounding box associated with the score.

At 220, the device 105 may perform partitioned object detection. In some examples, at 220, the device 105 may receive a second frame (e.g., a subsequent frame) and detect object recognition information associated with the candidate object in the second frame. The second frame may be, for example, a video image included in the video captured by the device 105. In some examples, the second frame may be a video image received by the device 105 from the other device 105, the server 110, or the database 115. The device 105 may process the second frame, for example, based on the first frame (e.g., after processing the first frame via the object detection at 205, the motion estimation at 210, the tuning at 215, and the tracking logic at 225, as described herein). The second frame may include the candidate object.

In some examples, the candidate object may be absent from the second frame. For example, at 220, the device 105 may detect, via the machine learning component (e.g., the cascade neural network), second object recognition information based on one or more of the first object recognition information, the second frame, or a portion of the second frame. The second object recognition information may include one or more of the candidate object in the second frame, a second candidate bounding box associated with the candidate object, or one or more features of the candidate object. The detection of object recognition information at 205 (e.g., the detection of first object recognition information) and the detection of object recognition information at 220 (e.g., the detection of second object recognition information) may include a full scan of a frame (e.g., a full scan of the first frame at 205) and a partitioned scan of a frame (e.g., a partitioned scan of the second frame, or one or more portions of the second frame, at 220).

In some examples, partitioned scanning may include partitioned object detection. For example, at 220, the device 105 may detect object recognition information associated with the candidate object in a frame (e.g., the first frame, the second frame, or any subsequent frame) based on a scale associated with the frame or scales associated with different portions of the frame. At 220, the device 105 may detect object recognition information based on one or more scales and partitions:(1) a scale for a first portion (e.g., a left part) of a frame; (2) a scale for a second portion (e.g., a right part) of the frame; (3) a scale for the entire frame; and (4) a reduced scale for the entire frame.

In some examples, the device 105 may assign or set the scales for the frame and the portions of the frame. The device 105 may detect object recognition information associated with the candidate object in the frame, based on the scales. In some examples, the device 105 may assign or set the scales for the frame and the portions of the frame based on a frame counter (e.g., a frame number). At 220, the device 105 may detect object recognition information (e.g., partitioned object detection) based on the frame counter. For example, for each frame, the device 105 may iterate the frame counter (e.g., between 1 to 10) and determine partitions and scales for processing the frame, based on the frame counter. In some examples, the device 105 may determine the partitions and scales based on multiple frame counter thresholds (e.g., a first scale for a first through fourth frame, a second scale for a fifth frame and a sixth frame, a third scale for a seventh frame).

For example, for a first frame (e.g., object detection for an initial frame), the device 105 may detect object recognition information associated with the candidate object in the entire first frame, at a first scale. The device 105 may capture multiple subsequent frames, and in some examples, detect object recognition information associated with the candidate object in one or more of the subsequent frames (e.g., over a set of contiguous frames, over a set of non-contiguous frames). For example, for a subsequent frame (e.g., partitioned object detection for a second frame, a third frame, a fifth frame, etc.), the device 105 may detect object recognition information associated with the candidate object in a portion (e.g., a left part) of the subsequent frame, at a second scale different from the first scale (e.g., at a lower scale than the first scale).

In a different subsequent frame (e.g., partitioned object detection for a sixth frame), the device 105 may detect object recognition information associated with the candidate object in a portion (e.g., a right part) of the subsequent frame, at a scale different from the first scale (e.g., at a lower scale than the first scale, at the second scale). In a different subsequent frame (e.g., partitioned object detection for a seventh frame), the device 105 may detect object recognition information associated with the candidate object in the entire subsequent frame, at the first scale or at a scale different from the first scale (e.g., at a lower scale than the first scale, at the second scale).

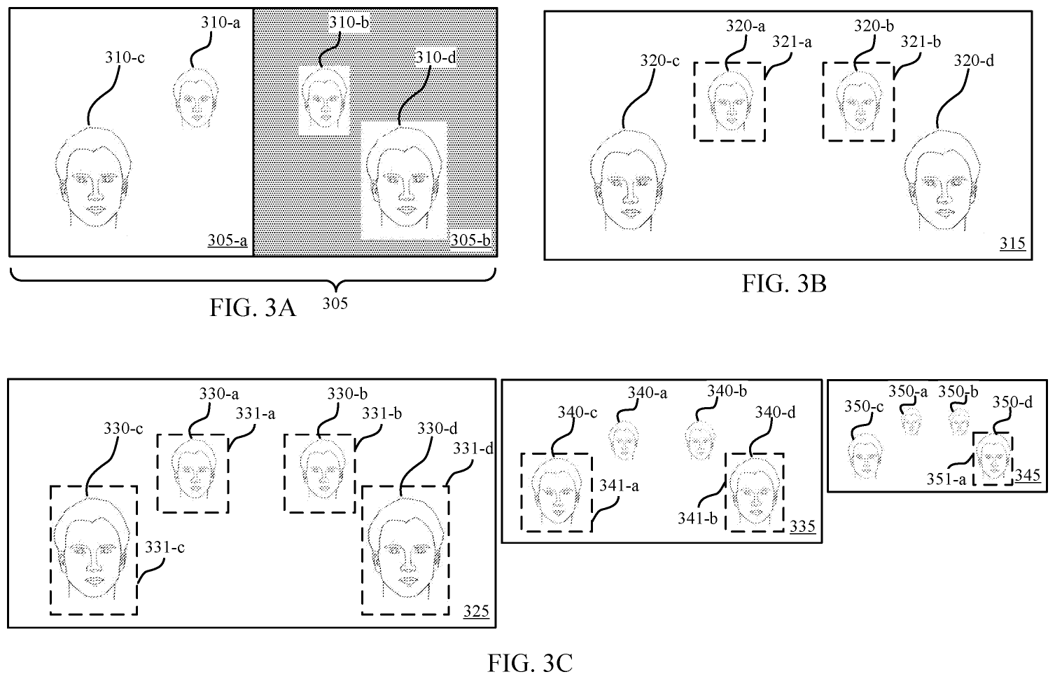

In some examples, using the partitioned object detection, the device 105 may distribute a workload associated with object detection. For example, the device 105 may distribute the workload among processors of the device 105 based on the multiple scales and partitions. Examples of aspects of partitioned object detection are described herein with respect to FIG. 3. The device 105 may perform partitioned object detection simultaneously at a lower process cycle, for example, with rotated partition settings. For example, the device 105 may adjust an angular rotation of the frame or adjust an angular rotation of one or more candidate object regions (e.g., adjust an angular rotation of a candidate object, a candidate bounding box associated with the candidate object) when performing partitioned object detection. In some examples, the device 105 may perform partitioned object detection simultaneously with the motion estimation and the tuning.

At 225, the device 105 may track a candidate object based on motion information associated with the candidate object, object recognition information associated with the candidate object, or both. In some examples, the device 105 may track the candidate object based on the object recognition information determined at 205, the motion information as determined at 210, the refined object recognition information as determined at 215, the object recognition information as determined at 220, or a combination thereof. The device 105, for example, may capture multiple subsequent frames, and in some examples, track a candidate object in one or more of the subsequent frames (e.g., over a set of contiguous frames, over a set of non-contiguous frames). For example, the device 105 may track the candidate object over one or more subsequent frames (e.g., a second frame, a third frame, a fifth frame). The device 105 may include logic configured to track the candidate object based on one or more of the object recognition information determined at 205, the motion information as determined at 210, the refined object recognition information as determined at 215, and the object recognition information as determined at 220.

According to examples of aspects described herein, the device 105 may be configured to track candidate objects based on candidate bounding boxes (e.g., ‘Onet_Boxes’, ‘Miss_Boxes’, and ‘Par_Boxes’) as determined based on the object recognition information determined at 205, the motion information as determined at 210, the refined object recognition information as determined at 215, the object recognition information as determined at 220, or a combination thereof. In some examples, the device 105 may compare confidence scores of candidate bounding boxes included in the refined object recognition information as determined at 215 (e.g., ‘Onet_Boxes’ and ‘Miss_Boxes’ included in the predicted output from O-Net) to a threshold (e.g., a confidence score threshold). For example, the device 105 may identify confidence scores of the candidate bounding boxes (e.g., ‘Onet_Boxes’ and ‘Miss_Boxes’) determined by at 215 which satisfy the predefined threshold (e.g., are higher than the predefined threshold). The device 105 may determine whether the candidate bounding boxes (e.g., ‘Onet_Boxes’ and ‘Miss_Boxes’) having confidence scores satisfying the threshold overlap (or do not overlap) with candidate bounding boxes included in the object recognition information as determined at 220 (e.g., ‘Par_Boxes’ determined from the partitioned object detection). In some examples, the device 105 may track candidate objects based on the candidate bounding boxes (e.g., ‘Onet_Boxes’ and ‘Miss_Boxes’) determined by at 215 which have confidence scores that both satisfy the threshold and do not overlap with the candidate bounding boxes (e.g., ‘Par_Boxes’) determined by at 220.

Alternatively or additionally, the device 105 may identify candidate bounding boxes (e.g., ‘Onet_Boxes’ and ‘Miss_Boxes’) determined by at 215 which have confidence scores that satisfy the threshold but overlap with the candidate bounding boxes (e.g., ‘Par_Boxes’) determined by at 220. In such examples, the device 105 may calculate an average value of the confidence scores which satisfy the threshold and are associated with overlapping candidate bounding boxes (e.g., ‘Onet_Boxes’ and ‘Miss_Boxes’ which overlap the ‘Par_Boxes’). In some examples, the device 105 may track candidate objects based on the average value of the confidence scores. At 225, the device 105 may identify candidate bounding boxes (e.g., ‘Miss_Boxes’) determined by at 215 which overlap with the candidate bounding boxes (e.g., ‘Par_Boxes’) determined at 220. In such examples, the device 105 may remove duplicate candidate bounding boxes (e.g., remove duplicate candidate bounding boxes among the ‘Miss_Boxes’ and the ‘Par_Boxes’) for tracking candidate objects.

According to examples of aspects described herein, the device 105 may provide reliable frame-by-frame object detection in combination with object tracking. Aspects of the motion estimation, the tuning, the partitioned object detection, and the tracking logic may be repeated or iterated over multiple frames. For example, the device 105 may obtain or fetch a new frame and repeat aspects of the motion estimation, the tuning, the partitioned object detection, and the tracking logic 225 described herein for each new frame.

FIGS. 3A through 3C illustrate example block diagrams describing frames 305 through 345 that support partitioning and tracking object detection in accordance with aspects of the present disclosure. In some examples, the block diagrams describing frames 305 through 345 may implement aspects of the multimedia system 100. For example, the block diagrams describing frames 305 through 345 may implement aspects of partitioned object detection as described herein. In some examples, FIGS. 3A through 3C illustrate examples of object detection in which the device 105 may perform partitioned object detection and object tracking for frames of a frame sequence based on different scales and frame types. The object detection and tracking described with respect to FIGS. 3A through 3C may include face detection and face tracking, such as in a driver monitoring system, for example. The operations of block diagrams describing frames 305 through 345 may be implemented by a device 105 or its components as described herein. For example, the operations of block diagrams describing frames 305 through 345 may be performed by a multimedia manager or a machine learning component, or both as described with reference to FIG. 1.

FIG. 3A illustrates an example of object detection in which the device 105 performs partitioned object detection at a reduced scale for sub-frames of a frame 305. For example, the device 105 may partition the frame 305 into sub-frames 305-a and 305-b (e.g., left and right parts of the frame 305) and perform object detection based on the reduced scale for each of the sub-frames 305-a and 305-b. The device 105 may perform object detection based on the reduced scale, for example, for detecting candidate objects in the frame 305 which are within a size range associated with smaller candidate objects in the frame 305. In some examples, based on the reduced scale, the device 105 may detect for candidate objects in the frame 305 which are smaller in size compared to candidate objects 310-a through 310-d in the frame 305.

In some examples, the device 105 may classify object detection of the sub-frame 305-a (e.g., the left part of the frame 305) based on the reduced scale (e.g., smallest scale) as a first type (e.g., Type 1) object detection. The device 105 may perform object detection of the sub-frame 305-a based on the reduced scale, for example, for a fifth frame of a sequence of frames (e.g., frame count 5). In some examples, based on the reduced scale, the device 105 may detect for candidate objects in the sub-frame 305-a which are smaller in size compared to the candidate object 310-a. In some examples, the device may classify object detection of the sub-frame 305-b (e.g., the right part of the frame 305) based on the reduced scale (e.g., smallest scale) as a second type (e.g., Type 2) object detection. The device 105 may perform object detection of the sub-frame 305-a based on the reduced scale, for example, for a sixth frame of a sequence of frames (e.g., frame count 6). In some examples, based on the reduced scale, the device 105 may detect for candidate objects in the sub-frame 305-b which are smaller in size compared to the candidate object 310-b.

By performing object detection on the sub-frames 305-a and 305-b at the reduced scale (e.g., Type 1 object detection and Type 2 object detection) as described herein, the device 105 may perform object detection more efficiently compared to performing object detection on the entire frame 305 at the reduced scale. In the example of FIG. 3A, there are no candidate objects in the frame 305 (e.g., the sub-frames 305-a and 305-b) that are smaller in size compared to the candidate objects 310-a through 310-d, and the device 105 may output a result indicating the device 105 has not detected any candidate objects based on the reduced scale (e.g., smallest scale). In an example aspect of object detection directed toward a driver monitoring system, the device 105 may detect for passengers (e.g., faces) located in a third row of the vehicle (e.g., a third row of a sport utility vehicle or minivan).

FIG. 3B illustrates an example of object detection in which the device 105 performs partitioned object detection at a medium scale (e.g., a larger scale compared to the reduced scale described with respect to FIG. 3A). In some examples, the device 105 may classify object detection of the frame 315 based on the medium scale as a third type (e.g., Type 3) object detection. The device 105 may perform object detection of the frame 315 based on the medium scale, for example, for odd-numbered frames (e.g., frames 3, 7, 9, and so on) of the sequence of frames, except for the fifth frame as described herein.

In some examples, based on the medium scale, the device 105 may detect for candidate objects in the frame 315 which are within a size range associated with relatively medium sized candidate objects in the frame 315. In an example, based on the medium scale, the device 105 may detect for candidate objects in the frame 315 which are smaller in size compared to candidate objects 320-c and 320-d in the frame 315, but larger in size compared to candidate objects associated with the reduced scale described with respect to the frame 305. In an example aspect of object detection directed toward a driver monitoring system, the device 105 may detect for passengers (e.g., faces) located in a second row of the vehicle.

In the example of FIG. 3B, candidate objects 320-a and 320-b in the frame 315 are smaller in size compared to the candidate objects 320-c and 320-d, but larger in size compared to candidate objects associated with the reduced scale described with respect to the frame 305, and the device 105 may output a result (e.g., candidate bounding boxes 321-a and 321-b) indicating the device 105 has detected candidate objects 320-a and 320-b based on the medium scale. For example, the device 105 may output Tar Boxes' associated with the candidate objects 320-a and 320-b detected by the device 105.

FIG. 3C illustrates an example of object detection in which the device 105 performs partitioned object detection at an increased scale (e.g., a larger scale compared to the medium scale described with respect to FIG. 3B). In some examples, the device 105 may classify object detection of the frame 325 based on the increased scale as Type 4 object detection. The device 105 may perform object detection of the frame 325 based on the increased scale, for example, for even-numbered frames (e.g., frames 2, 4, 8, and so on) of the sequence of frames, except for the sixth frame as described herein. In some examples, based on the increased scale, the device 105 may detect for candidate objects in the frame 325 which are within a size range associated with relatively medium and large sized candidate objects in the frame 325. In an example, based on the increased scale, the device 105 may detect for candidate objects in the frame 325 which are equal to or larger in size compared to candidate objects associated with the medium scale described with respect to the frame 315.

In an example aspect of object detection directed toward a driver monitoring system, the device 105 may detect for occupants (e.g., faces) located in a front row and second row of the vehicle. In the example of the frame 325 of FIG. 3C, candidate objects 330-a through 330-d in the frame 325 are equal or larger in size compared to candidate objects associated with the medium scale described with respect to the frame 315, and the device 105 may output a result (e.g., candidate bounding boxes 331-a through 331-d) indicating the device 105 has detected candidate objects 330-a through 330-d based on the increased scale. For example, the device 105 may output ‘Par_Boxes’ associated with the candidate objects 330-a and 330-d detected by the device 105. In some examples, the device 105 may modify the increased scale to detect for relatively large candidate objects. For example, the device 105 may detect for candidate objects in a frame 335 which are within a size range associated with relatively large sized candidate objects. Based on the modified scale, the device 105 may detect for candidate objects in the frame 335 which are equal or larger in size compared to candidate objects 330-c and 330-d.

In an example aspect of object detection directed toward a driver monitoring system, the device 105 may detect for a driver or passenger (e.g., faces) located in a front row of the vehicle. In the example of the frame 335 of FIG. 3C, candidate objects 340-c and 340-d in the frame 335 are equal or larger in size compared to candidate objects 330-c and 330-d, and the device 105 may output a result (e.g., candidate bounding boxes 341-a and 341-b) indicating the device 105 has detected candidate objects 340-c and 340-d based on the modified scale. For example, the device 105 may output ‘Par_Boxes’ associated with the candidate objects 340-c and 340-d detected by the device 105.

In another example aspect of object detection directed toward a driver monitoring system, the device 105 may detect for a driver (e.g., face) located in a driver seat of the vehicle. In the example of the frame 345 of FIG. 3C, candidate objects 350-c and 350-d in the frame 335 are equal or larger in size compared to candidate objects 330-c and 330-d, and the device 105 may output a result (e.g., candidate bounding box 351-a) indicating the device 105 has detected candidate object 350-d based on the modified scale and, for example, a setting of the device 105 (e.g., candidate objects located at a right side of the frame 345, for example, located in a driver seat). The device 105 may output a ‘Par_Box’ associated with the candidate object 350-d (e.g., the driver) detected by the device 105.

The device 105 may perform object detection for frames in a frame sequence separately (e.g., the device 105 may separately deploy frames, sub-frames and scales for object detection with respect to the frames and sub-frames) to improve runtime associated with object detection. In some examples, the device 105 may output candidate bounding boxes (e.g., ‘Par_Boxes’) associated with candidate objects detected based on the partitioned object detection. According to examples of aspects described herein, the device 105 may perform object detection based on the medium scale more often compared to performing object detection based on the reduced scale. In some examples, the device 105 may perform object detection based on the increased scale (e.g., for driver monitoring) more often compared to performing object detection based on the medium scale.

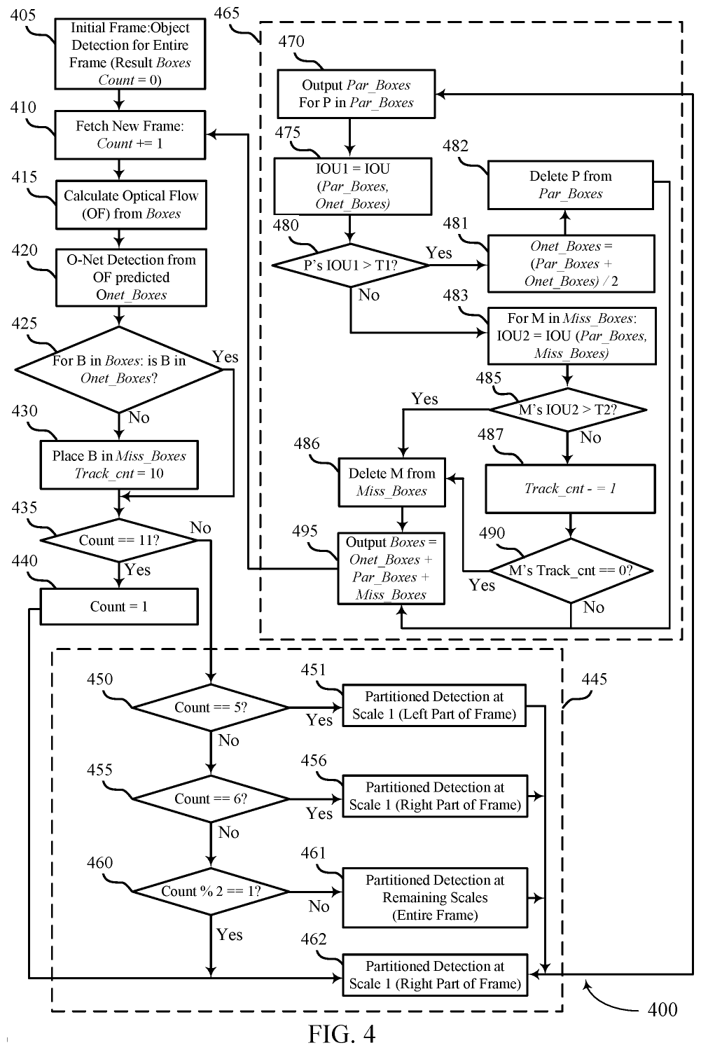

FIG. 4 illustrates an example flowchart 400 that supports partitioning and tracking object detection in accordance with aspects of the present disclosure. In some examples, flowchart 400 may implement aspects of the multimedia system 100. For example, the object detection may include face detection associated with a driver monitoring system (e.g., a vehicle based, in-cabin driver monitoring system). The operations of flowchart 400 may be implemented by a device 150 or its components as described herein. For example, the operations of flowchart 400 may be performed by a multimedia manager or a machine learning component, or both as described herein. In some examples, the device 105 may execute a set of instructions to control the functional elements of the device to perform the functions described herein. Additionally or alternatively, the device 105 may perform aspects of the functions described herein using special-purpose hardware.

At 405, the device 105 may receive a first frame (e.g., an initial frame) including a candidate object, and in some examples, detect object recognition information associated with the candidate object in the first frame. The first frame may be, for example, a video image included in video captured by or received by the device 105. The device 105 may detect, via the multimedia manager or the machine learning component (e.g., the cascade neural network), or both, first object recognition information based on one or more of the first frame or a portion of the first frame. The first object recognition information may include one or more of the candidate object or a first candidate bounding box associated with the candidate object. In some examples, the object recognition information described herein may include facial recognition information, and the candidate object may include a candidate face. The object detection, at 405, may be an example of aspects of the object detection as described herein. In some examples, at 405, the device 105 may also set a Boxes Count to ‘0’.

At 410, the device 105 may obtain (e.g., fetch) a new frame. The new frame may be a subsequent frame of a sequence of frames associated with the initial frame, as described herein. At 410, the device 105 may set a frame count to ‘1’ (e.g., may add a ‘1’ to the frame count). At 415, the device 105 may estimate, via the multimedia manager or the machine learning component (e.g., the cascade neural network), or both, motion information associated with the candidate object in the first frame. The device 105 may estimate the motion information using one or more optical flow techniques as described herein. For example, at 415, the device 105 may calculate optical flow (OF) based on Boxes (e.g., candidate bounding boxes associated with the candidate object as described herein). The estimation of motion information, at 415, may be an example of aspects of motion estimation described herein.

At 420 through 435, the device 105 may process the estimated motion (e.g., process the optical flow (OF)). At 420 through 430, for example, the device 105 may process the estimated motion (e.g., refine results associated with the estimated motion) determined at 415. The processing (e.g., refining) of the estimated motion at 420 through 435 may be an example of aspects of tuning as described herein. For example, at 420 through 430, the device 105 may output different groups of candidate bounding boxes (e.g., ‘Onet_Boxes’ and ‘Miss_Boxes’). In some examples, the device 105 may compare the candidate bounding boxes determined at 415 (e.g., determined using optical flow techniques) to the candidate bounding boxes determined at 420 (e.g., determined using tuning via the multimedia manager or the machine learning component (e.g., the cascade neural network), or both).

At 420, the device 105 may perform O-Net detection based on the OF predicted candidate bounding boxes (e.g., OF predicted Onet_Boxes) determined at 415. The device 105, for example, may narrow or refine the number of OF predicted candidate bounding boxes based on confidence scores associated therewith (e.g., based on confidence scores which satisfy a threshold, for example, exceed a threshold). In some examples, the device 105 may perform O-Net detection using via the multimedia manager or the machine learning component (e.g., cascade learning network, O-Net), or both. The device 105 may output a refined number of Onet_Boxes.

At 425, the device 105 may determine whether candidate bounding boxes (e.g., ‘B’) of Boxes are present in (‘Yes’) or missing from (‘No’) Onet_Boxes. At 430, the device 105 may place the missing candidate bounding boxes in Miss_Boxes. In some examples, at 430, the device 105 may set a frame count number for tracking candidate objects associated with the candidate bounding boxes placed in Miss_Boxes (e.g., set the Track_cnt) to ‘10’. At 435, the device 105 may check the frame count number of a current frame. In an example, at 435, the device 105 may determine whether a current frame is the 11th frame (e.g., Count 11?). If the current frame is the 11th frame (e.g., Count==11), the device 105 may reset the frame counter to ‘1’ at 440, for example, as part of partition control for deciding which scale to use for object detection. If the current frame is, for example, the 10th frame or earlier (e.g., Count≠11), the device 105 may proceed to 445.

At 445, the device 105 may perform partitioned object detection according to examples of aspects described herein. At 450 through 462, for example, the device 105 may perform partitioned object detection based on frame count number and scales, according to examples of aspects described herein. The partitioned object detection at 450 through 462 may be examples of aspects of the partitioned object detection 220 of FIG. 2 and diagrams 305 through 345 of FIGS. 3A through 3C as described herein.

At 450, the device 105 may determine whether the current frame is the 5th frame (e.g., Count==5?). At 450, if the device 105 determines the current frame is the 5th frame (e.g., Count==5), the device 105 may proceed to performing partitioned object detection at 451. In some examples, at 451, the device 105 may perform object detection for a left part of the frame, for example at a scale 1. Scale 1 may be a reduced scale as described herein with respect to FIG. 3A, for example, but is not limited thereto. Alternatively at 450, if the device 105 determines the current frame is not the 5th frame (e.g., Count≠5), the device 105 may proceed to 455.

At 455, the device 105 may determine whether the current frame is the 6th frame (e.g., Count==6?). At 455, if the device 105 determines the current frame is the 6th frame (e.g., Count==6), the device 105 may proceed to performing partitioned object detection at 456. In some examples, at 456, the device 105 may perform object detection for a right part of the frame, for example at the scale 1. Alternatively at 455, if the device 105 determines the current frame is not the 6th frame (e.g., Count≠6), the device 105 may proceed to 460.

At 460, the device 105 may determine whether the current frame, when the frame number thereof is divided by ‘2’, is the 1st frame (e.g., (Count/2)==1?). At 460, in the affirmative (e.g., (Count/2)==1), the device 105 may proceed to performing partitioned object detection at 461. In some examples, at 461, the device 105 may perform object detection for the entire frame, for example at the remaining scales (e.g., scales different from scale 1). Alternatively at 460, for a negative confirmation, the device 105 may proceed to performing partitioned object detection at 462. In some examples, at 462, the device 105 may perform object detection for the right part of the frame, for example at the scale 1.

At 465, the device 105 may perform object tracking according to examples of aspects described herein. At 470 through 495, for example, the device 105 may perform object tracking based on partitioned object detection as described herein. The object tracking at 470 through 495 may be examples of aspects of object tracking using the tracking logic 225 as described herein. In the example at 470 through 495, the device 105 may track candidate objects based on candidate bounding boxes (e.g., ‘Onet_Boxes’, ‘Miss_Boxes’, and ‘Par_Boxes’).

At 470, the device 105 (e.g., tracking logic) may identify the candidate bounding boxes determined by partitioned object detection (‘Par_Boxes’). For example, the device may identify one or more candidate bounding boxes (‘Par_Boxes’). At 475, the device 105 may determine the intersection over union (e.g., IOU1) between ‘Par_Boxes’ and corresponding ‘Onet_Boxes’ (e.g., candidate bounding boxes determined by the refining using O-Net). At 480, for example, the device 105 may compare the IOU1 of a ‘Par_Box’ (e.g., ‘P’) to a threshold T1 and determine, for example, whether the IOU1 satisfies the threshold T1 (e.g., determine whether the area of the IOU1 is greater than the threshold T1). If the device 105 determines the IOU1 satisfies the threshold T1 (‘Yes’), the device 105 may proceed to 481, where the device 105 may resize an ‘Onet_Box’ corresponding to the ‘Par_Box’ (e.g., ‘P’) to an average size, for example, based on the candidate bounding boxes in ‘Onet_Boxes’ and the candidate bounding boxes in ‘Par_Boxes’. In some examples, the device 105 may calculate the average size based on ‘Onet_Boxes’=(‘Par_Boxes’+‘Onet_Boxes’)/2). At 482, the device 105 may remove the ‘Par_Box’ (e.g., ‘P’) from the candidate bounding boxes in ‘Par Boxes’.

If the device 105 determines the IOU1 fails to satisfy the threshold T1 (‘No’), the device 105 may proceed to 483 through 495, where the device 105 may determine whether any ‘Miss_Boxes’ were detected by the partitioned object detection. At 483, for example, the device 105 may determine the intersection over union (e.g., IOU2) between the ‘Par_Boxes’ and corresponding ‘Miss_Boxes’. At 485, for example, the device 105 may compare the IOU2 of a ‘Miss_Box’ (e.g., ‘M’) to a threshold T2 and determine, for example, whether the IOU2 satisfies the threshold T2 (e.g., determine whether the area of the IOU2 is greater than the threshold T2). If the device 105 determines the IOU2 satisfies the threshold T1 (‘Yes’), the device 105 may proceed to 486, where the device 105 may remove the ‘Miss_Box’ (e.g., ‘M’) from the candidate bounding boxes in ‘Miss_Boxes’.

At 487 and 490, the device 105 may remove ‘Miss_Boxes’ having a frame counter equal to or greater than a frame counter threshold. For example, at 487, the device 105 may reduce the frame counter for the ‘Miss_Box’ (e.g., ‘M’) by ‘1’. At 490, the device 105 may determine whether the frame counter for the ‘Miss_Box’ (e.g., ‘M’) is equal to ‘0’. If the device 105 determines the frame counter for the ‘Miss_Box’ (e.g., ‘M’) is equal to ‘0’ (‘Yes’), the device 105 may proceed to 486, where the device 105 may remove the ‘Miss_Box’ (e.g., ‘M’) from the candidate bounding boxes in ‘Miss_Boxes’, for example, so as to refrain from tracking an object (e.g., a face) which has been detected previously but has been absent for 10 frames. Alternatively at 490, for a negative confirmation, the device 105 may proceed to 495.

At 495, the device 105 may accumulate or concatenate all remaining candidate bounding boxes among ‘Onet_Boxes’, ‘Miss_Boxes’, and ‘Par_Boxes’. For example, at 495, the device 105 may add the ‘Miss_Box’ (e.g., ‘M’) from 490 to the remaining candidate bounding boxes among ‘Onet_Boxes’, ‘Miss_Boxes’, and ‘Par_Boxes’. In some examples, the device 105 may add the resized ‘Onet_Box’ from 482. The device 105 may feed back the final detection (e.g., all remaining candidate bounding boxes) to 410, the beginning of a new cycle (e.g., a new frame), as the object detection and tracking information from the previous frame.

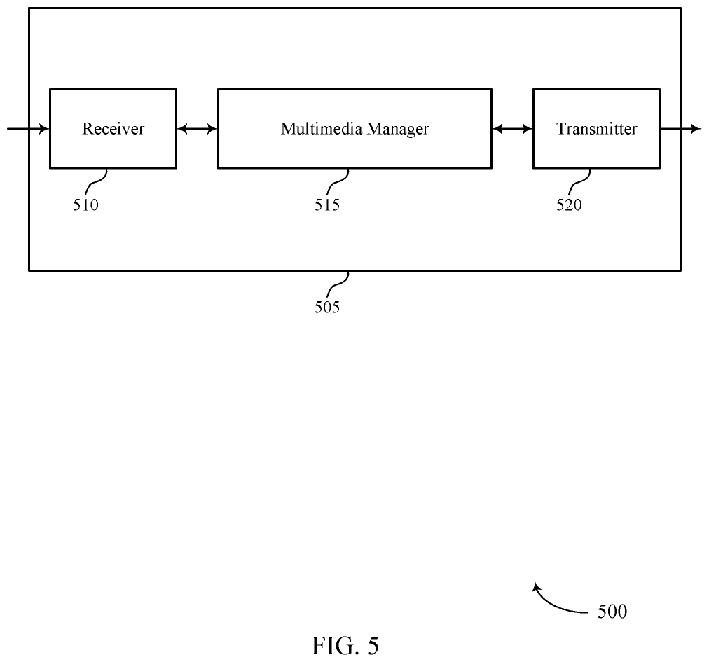

FIG. 5 shows a block diagram 500 of a device 505 that supports partitioning and tracking object detection in accordance with aspects of the present disclosure. The device 505 may be an example of aspects of a device as described herein. The device 505 may include a receiver 510, a multimedia manager 515, and a transmitter 520. The device 505 may also include a processor. Each of these components may be in communication with one another (e.g., via one or more buses).

The receiver 510 may receive information such as packets, user data, or control information associated with various information channels (e.g., control channels, data channels, and information related to partitioning and tracking object detection, etc.). Information may be passed on to other components of the device 505. The receiver 510 may be an example of aspects of the transceiver 820 described with reference to FIG. 8. The receiver 510 may utilize a single antenna or a set of antennas.

The multimedia manager 515 may receive a first frame including a candidate object. The multimedia manager 515 may detect, via a cascade neural network, first object recognition information based on one or more of the first frame or a portion of the first frame. The first object recognition information may include one or more of the candidate object or a first candidate bounding box associated with the candidate object. The multimedia manager 515 may detect, via the cascade neural network, second object recognition information based on one or more of the first object recognition information, a second frame, or a portion of the second frame. The second object recognition information may include one or more of the candidate object in the second frame, a second candidate bounding box associated with the candidate object, or one or more features of the candidate object. The multimedia manager 515 may estimate, via the cascade neural network, motion information associated with the candidate object in the first frame, and track the candidate object in the second frame based on the motion information. The multimedia manager 515 may be an example of aspects of the multimedia manager 810 described herein.

The multimedia manager 515, or its sub-components, may be implemented in hardware, code (e.g., software or firmware) executed by a processor, or any combination thereof. If implemented in code executed by a processor, the functions of the multimedia manager 515, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The multimedia manager 515, or its sub-components, may be physically located at various positions, including being distributed such that portions of functions are implemented at different physical locations by one or more physical components. In some examples, the multimedia manager 515, or its sub-components, may be a separate and distinct component in accordance with various aspects of the present disclosure. In some examples, the multimedia manager 515, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 520 may transmit signals generated by other components of the device 505. In some examples, the transmitter 520 may be collocated with a receiver 510 in a transceiver module. For example, the transmitter 520 may be an example of aspects of the transceiver 820 described with reference to FIG. 8. The transmitter 520 may utilize a single antenna or a set of antennas.

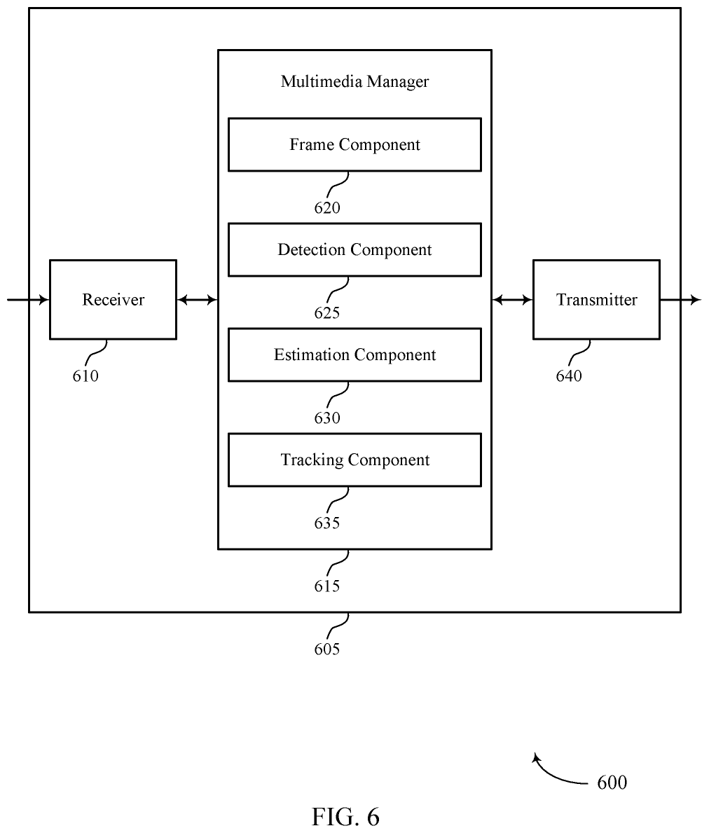

FIG. 6 shows a block diagram 600 of a device 605 that supports partitioning and tracking object detection in accordance with aspects of the present disclosure. The device 605 may be an example of aspects of a device 505 or a device 115 as described herein. The device 605 may include a receiver 610, a multimedia manager 615, and a transmitter 640. The device 605 may also include a processor. Each of these components may be in communication with one another (e.g., via one or more buses).

The receiver 610 may receive information such as packets, user data, or control information associated with various information channels (e.g., control channels, data channels, and information related to partitioning and tracking object detection, etc.). Information may be passed on to other components of the device 605. The receiver 610 may be an example of aspects of the transceiver 820 described with reference to FIG. 8. The receiver 610 may utilize a single antenna or a set of antennas.

The multimedia manager 615 may be an example of aspects of the multimedia manager 515 as described herein. The multimedia manager 615 may include a frame component 620, a detection component 625, an estimation component 630, and a tracking component 635. The multimedia manager 615 may be an example of aspects of the multimedia manager 810 described herein.

The frame component 620 may receive a first frame including a candidate object. The detection component 625 may detect, via a cascade neural network, first object recognition information based on one or more of the first frame or a portion of the first frame.

The first object recognition information may include one or more of the candidate object or a first candidate bounding box associated with the candidate object. The detection component 625 may detect, via the cascade neural network, second object recognition information based on one or more of the first object recognition information, a second frame, or a portion of the second frame. The second object recognition information may include one or more of the candidate object in the second frame, a second candidate bounding box associated with the candidate object, or one or more features of the candidate object. The estimation component 630 may estimate, via the cascade neural network, motion information associated with the candidate object in the first frame. The tracking component 635 may track the candidate object in the second frame based on the motion information.

The transmitter 640 may transmit signals generated by other components of the device 605. In some examples, the transmitter 640 may be collocated with a receiver 610 in a transceiver module. For example, the transmitter 640 may be an example of aspects of the transceiver 820 described with reference to FIG. 8. The transmitter 640 may utilize a single antenna or a set of antennas.

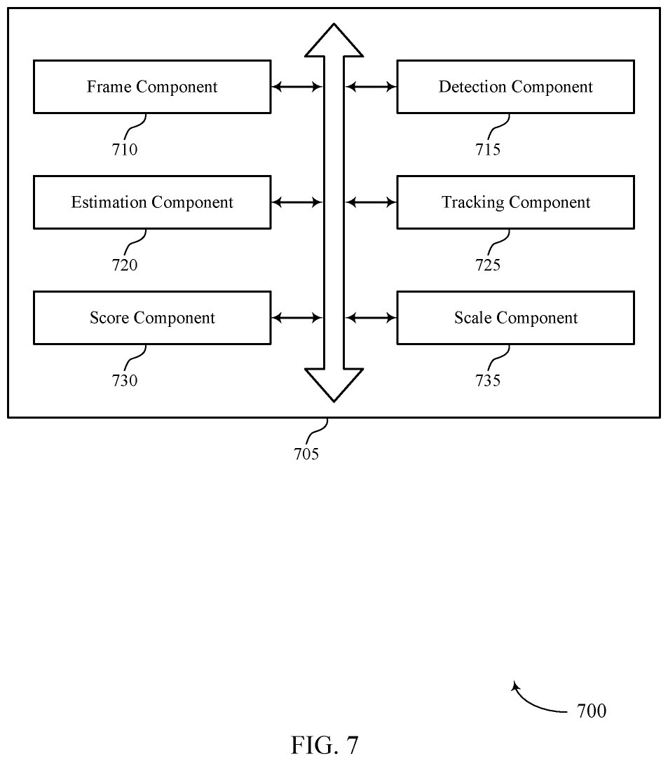

FIG. 7 shows a block diagram 700 of a multimedia manager 705 that supports partitioning and tracking object detection in accordance with aspects of the present disclosure. The multimedia manager 705 may be an example of aspects of a multimedia manager 515, a multimedia manager 615, or a multimedia manager 810 described herein. The multimedia manager 705 may include a frame component 710, a detection component 715, an estimation component 720, a tracking component 725, a score component 730, and a scale component 735. Each of these modules may communicate, directly or indirectly, with one another (e.g., via one or more buses).

The frame component 710 may receive a first frame including a candidate object. In some examples, the frame component 710 may capture one or more of the first frame, the second frame, or a third frame. In some examples, one or more of the first frame, the second frame, or the third frame are contiguous. In some examples, one or more of the first frame, the second frame, or the third frame are noncontiguous. The detection component 715 may detect, via a cascade neural network, first object recognition information based on one or more of the first frame or a portion of the first frame. The first object recognition information may include one or more of the candidate object or a first candidate bounding box associated with the candidate object. In some examples, the detection component 715 may detect, via the cascade neural network, second object recognition information based on one or more of the first object recognition information, a second frame, or a portion of the second frame. The second object recognition information may include one or more of the candidate object in the second frame, a second candidate bounding box associated with the candidate object, or one or more features of the candidate object.

In some examples, the detection component 715 may determine, via the cascade neural network, third object recognition information based on the motion information. The third object recognition information may include one or more of the candidate object, the first candidate bounding box associated with the candidate object, one or more object features of the candidate object, or a combination thereof, where tracking the candidate object in the second frame is based on the third object recognition information. In some examples, the detection component 715 may detect one or more additional candidate objects in one or more of the first frame or the portion of the first frame, where the third object recognition information includes one or more of the one or more additional candidate objects or additional candidate bounding boxes associated with the one or more additional candidate objects. In some examples, the detection component 715 may detect the first object recognition information based on a frame count associated with the first frame. In some examples, the detection component 715 may detect the second object recognition information based on one or more of the frame count associated with the first frame or a frame count associated with the second frame.

The estimation component 720 may estimate, via the cascade neural network, motion information associated with the candidate object in the first frame. In some examples, the estimation component 720 may estimate second motion information associated with the candidate object in the second frame. The tracking component 725 may track the candidate object in the second frame based on the motion information. In some examples, tracking component 725 may determine an absence of the candidate object over a quantity of frames, where the quantity of frames includes at least the first frame and the second frame. In some examples, the tracking component 725 may pause the tracking based on the absence of the candidate object over the quantity of frames.

In some examples, the tracking component 725 may compare the absence of the candidate object over the quantity of frames to a threshold, where pausing the tracking may be based on the absence of the candidate object over the quantity of frames satisfying the threshold. In some examples, the tracking component 725 may terminate the tracking based on the absence of the candidate object over the quantity of frames. In some examples, the tracking component 725 may compare the absence of the candidate object over the quantity of frames to a threshold, where terminating the tracking may be based on the absence of the candidate object over the quantity of frames satisfying the threshold. In some examples, the tracking component 725 may track the candidate object in the third frame based on the second motion information.

The score component 730 may determine, based on the second object recognition information, a first confidence score of one or more of the candidate object in the second frame, the second candidate bounding box associated with the candidate object, or the one or more features of the candidate object.

In some examples, the score component 730 may determine, based on the third object recognition information, a second confidence score of one or more of the candidate object, the first candidate bounding box associated with the candidate object, one or more object features of the candidate object, or a combination thereof, where tracking the candidate object in the second frame may be based on one or more of the first confidence score or the second confidence score. In some examples, the score component 730 may determine a union between the second object recognition information and the third object recognition information by comparing the second object recognition information and the third object recognition information.

In some examples, the score component 730 may determine that the union satisfies a threshold, where tracking the candidate object in the second frame may be based on the union satisfying the threshold. The scale component 735 may scale one or more of the first frame or the portion of the first frame based on a parameter, where detecting the first object recognition information including one or more of the candidate object or the first candidate bounding box associated with the candidate object may be based on the scaling. In some examples, the scale component 735 may scale one or more of the second frame or the portion of the second frame based on a parameter, where detecting the second object recognition information including one or more of the candidate object in the second frame, the second candidate bounding box associated with the candidate object, or the one or more features of the candidate object may be based on the scaling.

FIG. 8 shows a diagram of a system 800 including a device 805 that supports partitioning and tracking object detection in accordance with aspects of the present disclosure. The device 805 may be an example of or include the components of device 505, device 605, or a device as described herein. The device 805 may include components for bi-directional voice and data communications including components for transmitting and receiving communications, including a multimedia manager 810, an I/O controller 815, a transceiver 820, an antenna 825, memory 830, a processor 840, and a coding manager 850. These components may be in electronic communication via one or more buses (e.g., bus 845).

The multimedia manager 810 may receive a first frame including a candidate object. The multimedia manager 810 may detect, via a cascade neural network, first object recognition information based on one or more of the first frame or a portion of the first frame.

The first object recognition information may include one or more of the candidate object or a first candidate bounding box associated with the candidate object. The multimedia manager 810 may detect, via the cascade neural network, second object recognition information based on one or more of the first object recognition information, a second frame, or a portion of the second frame. The second object recognition information may include one or more of the candidate object in the second frame, a second candidate bounding box associated with the candidate object, or one or more features of the candidate object. The multimedia manager 810 may estimate, via the cascade neural network, motion information associated with the candidate object in the first frame, and track the candidate object in the second frame based on the motion information. As detailed above, the multimedia manager 810 and/or one or more components of the multimedia manager 810 may perform and/or be a means for performing, either alone or in combination with other elements, one or more operations for supporting partitioning and tracking object detection.

The I/O controller 815 may manage input and output signals for the device 805. The I/O controller 815 may also manage peripherals not integrated into the device 805. In some cases, the I/O controller 815 may represent a physical connection or port to an external peripheral. In some cases, the I/O controller 815 may utilize an operating system such as iOS, ANDROID, MS-DOS, MS-WINDOWS, OS/2, UNIX, LINUX, or another known operating system. In other cases, the I/O controller 815 may represent or interact with a modem, a keyboard, a mouse, a touchscreen, or a similar device. In some cases, the I/O controller 815 may be implemented as part of a processor. In some cases, a user may interact with the device 805 via the I/O controller 815 or via hardware components controlled by the I/O controller 815.

The transceiver 820 may communicate bi-directionally, via one or more antennas, wired, or wireless links as described herein. For example, the transceiver 820 may represent a wireless transceiver and may communicate bi-directionally with another wireless transceiver.

The transceiver 820 may also include a modem to modulate the packets and provide the modulated packets to the antennas for transmission, and to demodulate packets received from the antennas. In some cases, the device 805 may include a single antenna 825. However, in some cases, the device 805 may have more than one antenna 825, which may be capable of concurrently transmitting or receiving multiple wireless transmissions.

The memory 830 may include random access memory (RAM) and read-only memory (ROM). The memory 830 may store computer-readable, computer-executable code 835 including instructions that, when executed, cause the processor to perform various functions described herein. In some cases, the memory 830 may contain, among other things, a BIOS which may control basic hardware or software operation such as the interaction with peripheral components or devices.

The code 835 may include instructions to implement aspects of the present disclosure, including instructions to support image processing. The code 835 may be stored in a non-transitory computer-readable medium such as system memory or other type of memory. In some cases, the code 835 may not be directly executable by the processor 840 but may cause a computer (e.g., when compiled and executed) to perform functions described herein.

The processor 840 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In other cases, a memory controller may be integrated into the processor 840. The processor 840 may be configured to execute computer-readable instructions stored in a memory (e.g., the memory 830) to cause the device 805 to perform various functions (e.g., functions or tasks supporting partitioning and tracking object detection).

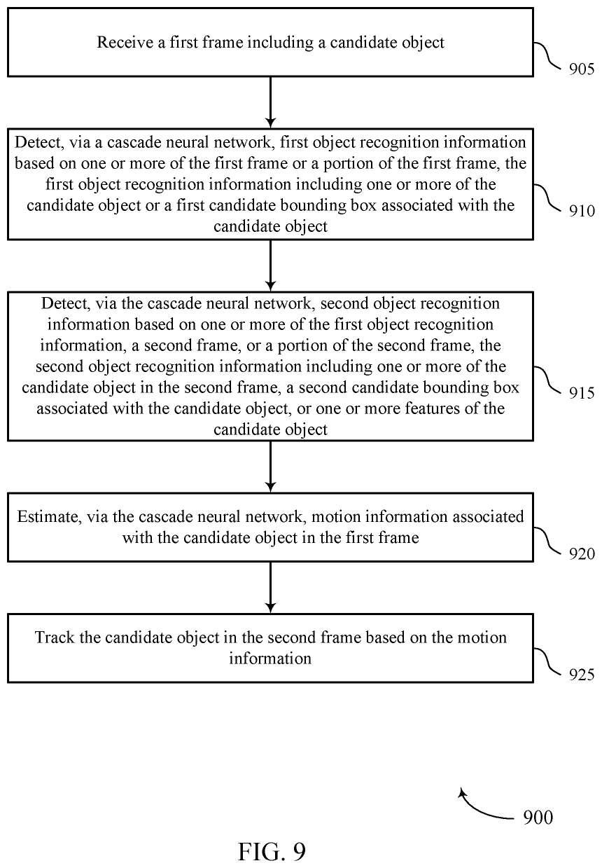

FIG. 9 shows a flowchart illustrating a method 900 that supports partitioning and tracking object detection in accordance with aspects of the present disclosure. The operations of method 900 may be implemented by a device or its components as described herein. For example, the operations of method 900 may be performed by a multimedia manager as described with reference to FIGS. 5 through 8. In some examples, a device may execute a set of instructions to control the functional elements of the device to perform the functions described herein. Additionally or alternatively, a device may perform aspects of the functions described herein using special-purpose hardware.

At 905, the device may receive a first frame including a candidate object. The operations of 905 may be performed according to the methods described herein. In some examples, aspects of the operations of 905 may be performed by a frame component as described with reference to FIGS. 5 through 8.

At 910, the device may detect, via a cascade neural network, first object recognition information based on one or more of the first frame or a portion of the first frame, the first object recognition information including one or more of the candidate object or a first candidate bounding box associated with the candidate object. The operations of 910 may be performed according to the methods described herein. In some examples, aspects of the operations of 910 may be performed by a detection component as described with reference to FIGS. 5 through 8.

At 915, the device may detect, via the cascade neural network, second object recognition information based on one or more of the first object recognition information, a second frame, or a portion of the second frame, the second object recognition information including one or more of the candidate object in the second frame, a second candidate bounding box associated with the candidate object, or one or more features of the candidate object. The operations of 915 may be performed according to the methods described herein. In some examples, aspects of the operations of 915 may be performed by a detection component as described with reference to FIGS. 5 through 8.

At 920, the device may estimate, via the cascade neural network, motion information associated with the candidate object in the first frame. The operations of 920 may be performed according to the methods described herein. In some examples, aspects of the operations of 920 may be performed by an estimation component as described with reference to FIGS. 5 through 8.

At 925, the device may track the candidate object in the second frame based on the motion information. The operations of 925 may be performed according to the methods described herein. In some examples, aspects of the operations of 925 may be performed by a tracking component as described with reference to FIGS. 5 through 8.

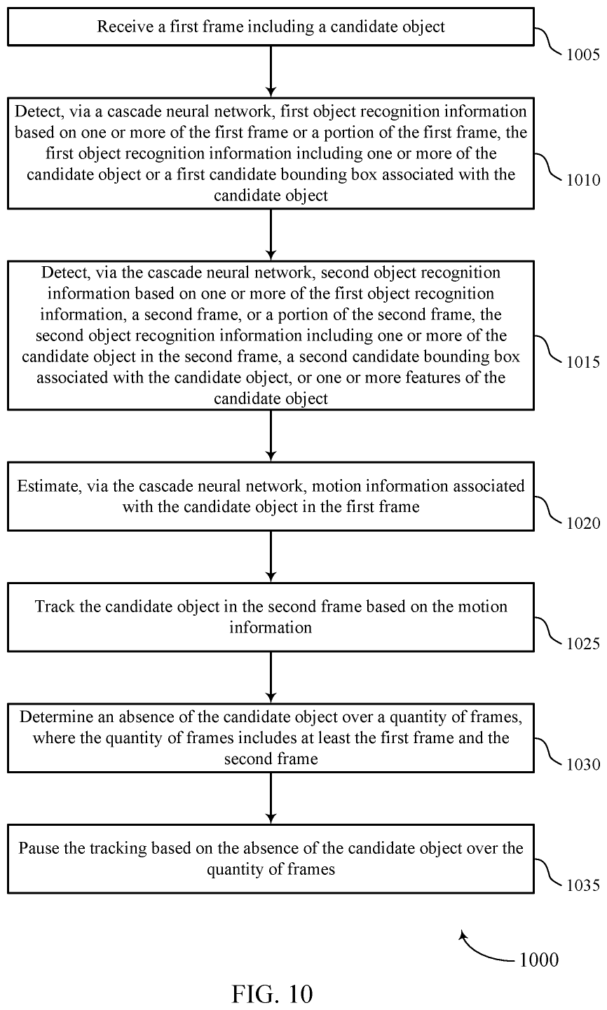

FIG. 10 shows a flowchart illustrating a method 1000 that supports partitioning and tracking object detection in accordance with aspects of the present disclosure. The operations of method 1000 may be implemented by a device or its components as described herein. For example, the operations of method 1000 may be performed by a multimedia manager as described with reference to FIGS. 5 through 8. In some examples, a device may execute a set of instructions to control the functional elements of the device to perform the functions described herein. Additionally or alternatively, a device may perform aspects of the functions described herein using special-purpose hardware.

At 1005, the device may receive a first frame including a candidate object. The operations of 1005 may be performed according to the methods described herein. In some examples, aspects of the operations of 1005 may be performed by a frame component as described with reference to FIGS. 5 through 8.

At 1010, the device may detect, via a cascade neural network, first object recognition information based on one or more of the first frame or a portion of the first frame, the first object recognition information including one or more of the candidate object or a first candidate bounding box associated with the candidate object. The operations of 1010 may be performed according to the methods described herein. In some examples, aspects of the operations of 1010 may be performed by a detection component as described with reference to FIGS. 5 through 8.

At 1015, the device may detect, via the cascade neural network, second object recognition information based on one or more of the first object recognition information, a second frame, or a portion of the second frame, the second object recognition information including one or more of the candidate object in the second frame, a second candidate bounding box associated with the candidate object, or one or more features of the candidate object. The operations of 1015 may be performed according to the methods described herein. In some examples, aspects of the operations of 1015 may be performed by a detection component as described with reference to FIGS. 5 through 8.

At 1020, the device may estimate, via the cascade neural network, motion information associated with the candidate object in the first frame. The operations of 1020 may be performed according to the methods described herein. In some examples, aspects of the operations of 1020 may be performed by an estimation component as described with reference to FIGS. 5 through 8.

At 1025, the device may track the candidate object in the second frame based on the motion information. The operations of 1025 may be performed according to the methods described herein. In some examples, aspects of the operations of 1025 may be performed by a tracking component as described with reference to FIGS. 5 through 8.

At 1030, the device may determine an absence of the candidate object over a quantity of frames, where the quantity of frames includes at least the first frame and the second frame. The operations of 1030 may be performed according to the methods described herein. In some examples, aspects of the operations of 1030 may be performed by a tracking component as described with reference to FIGS. 5 through 8.

At 1035, the device may pause the tracking based on the absence of the candidate object over the quantity of frames. The operations of 1035 may be performed according to the methods described herein. In some examples, aspects of the operations of 1035 may be performed by a tracking component as described with reference to FIGS. 5 through 8.

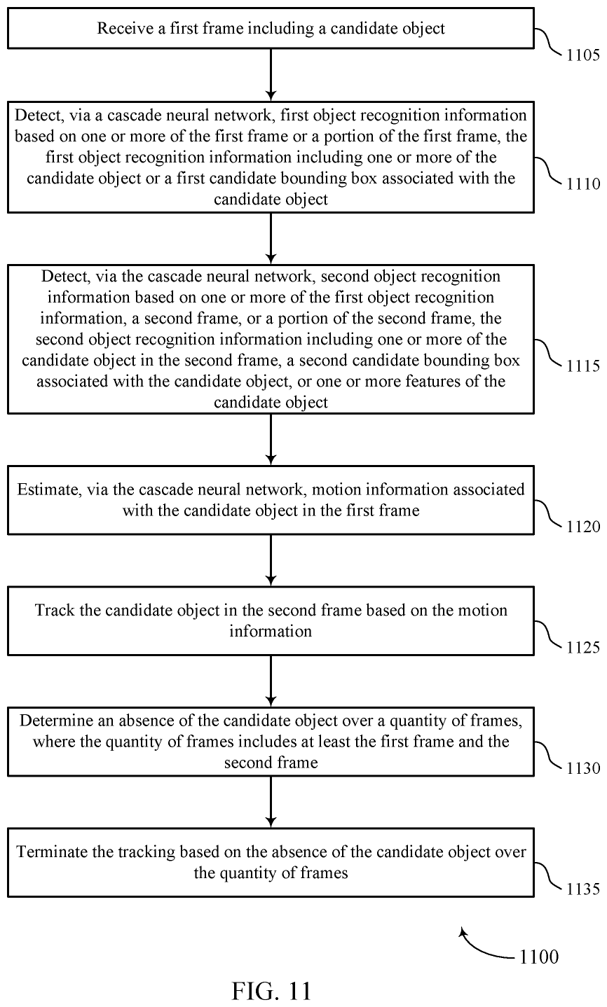

FIG. 11 shows a flowchart illustrating a method 1100 that supports partitioning and tracking object detection in accordance with aspects of the present disclosure. The operations of method 1100 may be implemented by a device or its components as described herein. For example, the operations of method 1100 may be performed by a multimedia manager as described with reference to FIGS. 5 through 8. In some examples, a device may execute a set of instructions to control the functional elements of the device to perform the functions described herein. Additionally or alternatively, a device may perform aspects of the functions described herein using special-purpose hardware.

At 1105, the device may receive a first frame including a candidate object. The operations of 1105 may be performed according to the methods described herein. In some examples, aspects of the operations of 1105 may be performed by a frame component as described with reference to FIGS. 5 through 8.

At 1110, the device may detect, via a cascade neural network, first object recognition information based on one or more of the first frame or a portion of the first frame, the first object recognition information including one or more of the candidate object or a first candidate bounding box associated with the candidate object. The operations of 1110 may be performed according to the methods described herein. In some examples, aspects of the operations of 1110 may be performed by a detection component as described with reference to FIGS. 5 through 8.

At 1115, the device may detect, via the cascade neural network, second object recognition information based on one or more of the first object recognition information, a second frame, or a portion of the second frame, the second object recognition information including one or more of the candidate object in the second frame, a second candidate bounding box associated with the candidate object, or one or more features of the candidate object. The operations of 1115 may be performed according to the methods described herein.

In some examples, aspects of the operations of 1115 may be performed by a detection component as described with reference to FIGS. 5 through 8.

At 1120, the device may estimate, via the cascade neural network, motion information associated with the candidate object in the first frame. The operations of 1120 may be performed according to the methods described herein. In some examples, aspects of the operations of 1120 may be performed by an estimation component as described with reference to FIGS. 5 through 8.

At 1125, the device may track the candidate object in the second frame based on the motion information. The operations of 1125 may be performed according to the methods described herein. In some examples, aspects of the operations of 1125 may be performed by a tracking component as described with reference to FIGS. 5 through 8.

At 1130, the device may determine an absence of the candidate object over a quantity of frames, where the quantity of frames includes at least the first frame and the second frame. The operations of 1130 may be performed according to the methods described herein. In some examples, aspects of the operations of 1130 may be performed by a tracking component as described with reference to FIGS. 5 through 8.

At 1135, the device may terminate the tracking based on the absence of the candidate object over the quantity of frames. The operations of 1135 may be performed according to the methods described herein. In some examples, aspects of the operations of 1135 may be performed by a tracking component as described with reference to FIGS. 5 through 8.

It should be noted that the methods described herein describe possible implementations, and that the operations and the steps may be rearranged or otherwise modified and that other implementations are possible. Furthermore, aspects from two or more of the methods may be combined. The described operations performed by a device may be performed in a different order than the order described, or the operations may be performed in different orders or at different times. Certain operations may also be left excluded or skipped, or other operations may be added. For example, a device may implement aspects of the techniques described herein as one or more stages, where stages may be implemented separately, may be implemented together to confirm decision making or provide more robustness to omni-directional object detection, and may be implemented in any combination and order based on system needs, device capability, etc.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for object detection or tracking, comprising:
receiving a first frame comprising a candidate object;
detecting, via a cascade neural network, first object recognition information based at least in part on one or more of the first frame or a portion of the first frame, the first object recognition information comprising one or more of the candidate object or a first candidate bounding box associated with the candidate object;
detecting, via the cascade neural network, second object recognition information based at least in part on one or more of the first object recognition information, a second frame, or a portion of the second frame, the second object recognition information comprising one or more of the candidate object in the second frame, a second candidate bounding box associated with the candidate object, or one or more features of the candidate object;
estimating, via the cascade neural network, motion information associated with the candidate object in the first frame; and
tracking the candidate object in the second frame based at least in part on the motion information.

2. The method of claim 1, further comprising:
determining, via the cascade neural network, third object recognition information based at least in part on the motion information, the third object recognition information comprising one or more of the candidate object, the first candidate bounding box associated with the candidate object, one or more object features of the candidate object, or a combination thereof,
wherein tracking the candidate object in the second frame is based at least in part on the third object recognition information.

3. The method of claim 2, further comprising:
detecting one or more additional candidate objects in one or more of the first frame or the portion of the first frame,
wherein the third object recognition information comprises one or more of the one or more additional candidate objects or additional candidate bounding boxes associated with the one or more additional candidate objects.

4. The method of claim 1, further comprising:
determining an absence of the candidate object over a quantity of frames, wherein the quantity of frames comprises at least the first frame and the second frame; and
pausing the tracking based at least in part on the absence of the candidate object over the quantity of frames.

5. The method of claim 4, further comprising:
comparing the absence of the candidate object over the quantity of frames to a threshold, wherein pausing the tracking is based at least in part on the absence of the candidate object over the quantity of frames satisfying the threshold.

6. The method of claim 1, further comprising:
determining an absence of the candidate object over a quantity of frames, wherein the quantity of frames comprises at least the first frame and the second frame; and
terminating the tracking based at least in part on the absence of the candidate object over the quantity of frames.

7. The method of claim 6, further comprising:
comparing the absence of the candidate object over the quantity of frames to a threshold, wherein terminating the tracking is based at least in part on the absence of the candidate object over the quantity of frames satisfying the threshold.

8. The method of claim 1, further comprising:
determining, based at least in part on the second object recognition information, a first confidence score of one or more of the candidate object in the second frame, the second candidate bounding box associated with the candidate object, or the one or more features of the candidate object; and
determining, based at least in part on third object recognition information, a second confidence score of one or more of the candidate object, the first candidate bounding box associated with the candidate object, one or more object features of the candidate object, or a combination thereof,
wherein tracking the candidate object in the second frame is based at least in part on one or more of the first confidence score or the second confidence score.

9. The method of claim 8, further comprising:
determining a union between the second object recognition information and the third object recognition information by comparing the second object recognition information and the third object recognition information; and
determining that the union satisfies a threshold, wherein tracking the candidate object in the second frame is based at least in part on the union satisfying the threshold.

10. The method of claim 1, wherein detecting the first object recognition information further comprises:
scaling one or more of the first frame or the portion of the first frame based at least in part on a parameter,
wherein detecting the first object recognition information comprising one or more of the candidate object or the first candidate bounding box associated with the candidate object is based at least in part on the scaling.

11. The method of claim 1, wherein detecting the second object recognition information further comprises:
scaling one or more of the second frame or the portion of the second frame based at least in part on a parameter,
wherein detecting the second object recognition information comprising one or more of the candidate object in the second frame, the second candidate bounding box associated with the candidate object, or the one or more features of the candidate object is based at least in part on the scaling.

12. The method of claim 1, wherein detecting the first object recognition information further comprises:
detecting the first object recognition information based at least in part on a frame count associated with the first frame; and
detecting the second object recognition information further comprises detecting the second object recognition information based at least in part on one or more of the frame count associated with the first frame or a frame count associated with the second frame.

13. The method of claim 1, further comprising:
capturing one or more of the first frame, the second frame, or a third frame;
estimating second motion information associated with the candidate object in the second frame; and
tracking the candidate object in the third frame based at least in part on the second motion information.

14. The method of claim 13, wherein one or more of the first frame, the second frame, or the third frame are contiguous.

15. The method of claim 13, wherein one or more of the first frame, the second frame, or the third frame are noncontiguous.

16. An apparatus for object detection or tracking, comprising:
a processor,
memory coupled with the processor; and
instructions stored in the memory and executable by the processor to cause the apparatus to:
receive a first frame comprising a candidate object;
detect, via a cascade neural network, first object recognition information based at least in part on one or more of the first frame or a portion of the first frame, the first object recognition information comprising one or more of the candidate object or a first candidate bounding box associated with the candidate object;
detect, via the cascade neural network, second object recognition information based at least in part on one or more of the first object recognition information, a second frame, or a portion of the second frame, the second object recognition information comprising one or more of the candidate object in the second frame, a second candidate bounding box associated with the candidate object, or one or more features of the candidate object;
estimate, via the cascade neural network, motion information associated with the candidate object in the first frame; and
track the candidate object in the second frame based at least in part on the motion information.

17. The apparatus of claim 16, wherein the instructions are further executable by the processor to cause the apparatus to:
determine, via the cascade neural network, third object recognition information based at least in part on the motion information, the third object recognition information comprising one or more of the candidate object, the first candidate bounding box associated with the candidate object, one or more object features of the candidate object, or a combination thereof,
wherein tracking the candidate object in the second frame is based at least in part on the third object recognition information.

18. The apparatus of claim 17, wherein the instructions are further executable by the processor to cause the apparatus to:
detect one or more additional candidate objects in one or more of the first frame or the portion of the first frame,
wherein the third object recognition information comprises one or more of the one or more additional candidate objects or additional candidate bounding boxes associated with the one or more additional candidate objects.

19. The apparatus of claim 16, wherein the instructions are further executable by the processor to cause the apparatus to:
determine an absence of the candidate object over a quantity of frames, wherein the quantity of frames comprises at least the first frame and the second frame; and
pause the tracking based at least in part on the absence of the candidate object over the quantity of frames.

20. An apparatus for object detection or tracking, comprising:
means for receiving a first frame comprising a candidate object;
means for detecting, via a cascade neural network, first object recognition information based at least in part on one or more of the first frame or a portion of the first frame, the first object recognition information comprising one or more of the candidate object or a first candidate bounding box associated with the candidate object;
means for detecting, via the cascade neural network, second object recognition information based at least in part on one or more of the first object recognition information, a second frame, or a portion of the second frame, the second object recognition information comprising one or more of the candidate object in the second frame, a second candidate bounding box associated with the candidate object, or one or more features of the candidate object;
means for estimating, via the cascade neural network, motion information associated with the candidate object in the first frame; and
means for tracking the candidate object in the second frame based at least in part on the motion information.
